(19) United States
(12) Patent Application Publication
(10) Pub. No.: US 2024/0338438 A1
(43) Pub. Date: Oct. 10, 2024

(54) CHARACTERIZING NETWORK SCANNERS BY CLUSTERING SCANNING PROFILES

(71) Applicants: THE PENN STATE RESEARCH FOUNDATION, University Park, PA (US); MERIT NETWORK, INC., Ann Arbor, MI (US)

(72) Inventors: John YEN, University Park, PA (US); Michalis KALLITSIS, Ann Arbor, MI (US); Vasant HONAVAR, University Park, PA (US); Junjie LIANG, University Park, PA (US); Don WELCH, University Park, PA (US)

(21) Appl. No.: 18/579,092

(22) PCT Filed: Jul. 13, 2022
(86) PCT No.: PCT/US2022/037018

§ 371 Date: Jan. 12, 2024

Related U.S. Application Data
(60) Provisional application No. 63/221,431, filed on Jul. 13, 2021.

(51) Int. Cl. G06F 21/55

(52) U.S. Cl. CPC G06F 21/554; G06F 2221/034

(57) ABSTRACT

Systems and methods are disclosed that implement a near-real-time approach for characterizing Internet Background Radiation to detect and characterize network scanner activity. Various implementations can use deep representation learning to address the high dimensionality of the scanning data. In one experiment, the combination of DNN-based Autoencoder algorithms and K-means clustering was used to detect scanner activity. The insights that can be gained from clustering Darknet data can be used in instances of high-intensity scanners, malware classes that are either newly emerging or long-standing, and other situations.

### CROSS-REFERENCE TO RELATED APPLICATIONS

This application claims priority to U.S. Provisional Application No. 63/221,431 filed on Jul. 13, 2021, the contents of which are incorporated by reference in their entireties.

### STATEMENT REGARDING FEDERALLY SPONSORED RESEARCH

This invention was made with government support under 17STQAC00001-03-00 awarded by the United States Department of Homeland Security. The Government has certain rights in the invention.

### BACKGROUND

Cyber-attacks present one of the most severe threats to the safety of citizenry and the security of the nation's critical infrastructure (i.e., energy grid, transportation network, health system, food and water supply networks, etc.). Adversaries are frequently engaged in acts of cyber-espionage ranging from targeting sensitive information critical to national security to stealing financial corporate assets and ransomware campaigns. For example, during the recent COVID-19 pandemic crisis, new cyber-attacks emerged that target organizations involved in developing vaccines or treatments, energy infrastructure, and new types of spam efforts appeared that targeted a wide variety of vulnerable populations. As the demand for monitoring and preventing cyber-attacks continues to increase, research and development continue to advance cybersecurity technologies not only to meet the growing demand for cybersecurity, but to advance and enhance the cybersecurity system used in various environments to monitor and prevent the cyber-attacks.

### SUMMARY

In accordance with some embodiments of the disclosed subject matter, systems, methods, and networks are provided that allow for near-real time analysis of large, heterogenous data sets reflective of network activity, to assess scanner activities.

In accordance with various embodiments, a method for detecting scanner activity is provided. The method comprises: collecting data relating to network scanner activity; determining a set of feature data of the network scanner activity data; processing the feature data using a deep representation learning algorithm to reduce dimensionality; generating clusters of scanner data from the reduced dimensionality data using a clustering algorithm; performing a cluster interpretation to determine characteristics of the clusters of scanner data; and using the characteristics to identify scanner activity of interest.

In accordance with other embodiments, a system may be provided for generating analyses of malicious activities, comprising: at least one processor; a communication device connected to the processor and configured to receive data reflective of network activity; a first memory in communication with the processor, and configured to store the data reflective of network activity; a second memory in communication with the processor, and configured to store secondary data relating to the network activity; a third memory having stored thereon a set of instructions which, when executed by the processor, cause the processor to: identify scanner data from the data reflective of network activity; associate the scanner data with secondary data to create combined scanner data; reduce the dimensionality of the combined scanner data; cluster the reduced dimensionality combined scanner data into scanner clusters; interpret features of the scanner clusters; assess the features to identify malicious network activities; and report the malicious network activities to a user.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a block level schematic of an example environment in which embodiments disclosed herein may be practiced.

FIG. 2 is block level schematic of an example system architecture according to embodiments herein.

FIGS. 3A and 3B is a 2-dimensional representation of an example clustering output produced according to embodiments herein.

FIG. 4 is a block level diagram illustration an example deep clustering workflow.

FIG. 5 depict cumulative distribution functions (CDFs) for numerical features that characterize scanning activity.

FIG. 6 is a block level flowchart illustrating an example method according to embodiments herein.

FIGS. 7A-7C depict performance of embodiments herein using various feature sets and clustering methods.

FIGS. 8A-8C depict performance aspects of embodiments herein.

FIGS. 9A-9C depict results of PCA experiments (9A, 9B) and clustering performance vs. dropout probability (9C).

FIG. 10 depicts an example of runtime performance of embodiments used to produce the results of FIGS. 7A-7C.

FIG. 11 depicts effects of cluster size on clustering performance.

FIG. 12 is a graph depicting aspects of clustering performance with respect to cluster size.

FIGS. 13A-13B are conceptual representations of types of decision trees in accordance with certain steps of methods disclosed herein.

FIG. 14 is a pair of graphs depicting Darknet scanner activity.

FIG. 15 is a pair of graphs illustrating Mirai onset in late 2016 and differences between clustering outcomes using a Wasserstein metric.

FIG. 16 is a bar chart illustrating example dissimilarity scores for the clusters of September 14th.

FIG. 17 is a pair of graphs illustrating example scanning traffic detected at Merit's network telescope for September and detection of temporal changes in the network telescope using Wasserstein distance.

FIG. 18 is a graph illustrating example optimal transport plans for September 13 and 14.

FIG. 19 is a pair of charts showing in-degree distribution of the graphs induced by the optimal plan for September 23 and 24.

FIG. 20 is a graph showing an example average silhouette score for all clusters of Feb. 20, 2022.

FIG. 21 is a pair of plot graphs illustrating example e-SNE visualizations for various clusters.

### DETAILED DESCRIPTION

A cyber-attack involves multiple phases and can span a long period of time. Usually, the first phase involves a “scanning” step. For instance, nefarious actors are frequently scanning for vulnerable machines on the Internet or performing reconnaissance. Similarly, malware that attempts to propagate from one compromised machine to other vulnerable devices are also engaged in malicious scanning activities. Such actions are difficult to be identified in an operational network because they are oftentimes low-volume and interwoven with other normal network traffic behaving similarly lest they are detected. However, developing practical solutions and systems for identifying such types of network threats is germane for maintaining the stability of the society. In addition, early detection and effective interpretation of these scanning behaviors can provide information for network security analysts because they may reveal the emergence of new malware, “zero-day” vulnerabilities that are being exploited, and changes in attack strategies.

Network telescopes, also known as “Darknets”, provide a unique opportunity for characterizing and detecting Internet-wide malicious scanning activities. A network telescope receives and records unsolicited traffic—coined as Internet Background Radiation (IBR)—destined to an unused but routed address space. This “dark IP space” hosts no services or devices, and therefore any traffic arriving to it is inherently malicious. No regular user traffic reaches the Darknet. Thus, network telescopes have been frequently used by the networking and security communities to shed light into dubious malware propagation and Internet scanning activities. They have also been used to detect cyber-threats (e.g., botnets DDoS and other types of attacks) and to detect novel attack patterns Network telescopes or “Darknets” provide a unique window into Internet-wide scanning activities involved in malware propagation, research scanning or network reconnaissance. Analyses of the resulting data can provide unique actionable insights into network scanning activities that can be used to prevent or mitigate cyber-threats.

However, challenges arise when attempting to detect threats using network telescope data. Specifically, identifying malicious activity patterns can be difficult or impossible using conventional techniques due to the sheer amount of data and the difficulty in determining signatures of malicious activity when numerous patterns may exist, each having different characteristics, and when no uniform identification criteria exist. For instance, an important task in this context is characterizing different network scanners based on their DNS name, the characteristics of their targets, their port scanning patterns, etc. This problem can be reformulated as a problem of how to cluster the scanner data.

There are several unique and non-trivial challenges presented by network telescope data. (i) The data are heterogeneous with regard to the types of observations included. For example, some of the observations are categorical, others are numeric, etc. Standard statistical methods are typically designed to handle a single type of data, which renders them not directly applicable to the problem of clustering scanner data; (ii) The number of observed variables, e.g., the ports scanned over the duration of monitoring, for each scanner can be in the order of thousands, resulting in extremely high-dimensional data. Distance calculations are known to be inherently unreliable in high-dimensional settings, making it challenging to apply standard clustering methods that rely on measuring distance between data samples to cluster them; (iii) Linear dimensionality reduction techniques such as Principal Component Analysis (PCA) fail to cope with non-linear interactions between the observed variables; and/or (iv) interpreting and detecting shifts in the clustering outcome, that may include hundreds of clusters with high-dimensional features.

Various systems and methods disclosed herein address challenges such as those above (and others), using various techniques for encoding and reducing data dimensionality as well as an unsupervised approach to characterizing network scanners using observations from a network telescope. In some embodiments, an example framework can characterize the structure and temporal evolution of Darknet data to address the challenges. The example frame work can include, but is not limited to: (i) extracting a rich, high-dimensional representation of Darknet “scanners” composed of features distilled from network telescope data; (ii) learning, in an unsupervised fashion, an information-preserving low-dimensional representation of these covariates (using deep representation learning) that is amenable to clustering; (iii) performing clustering of the scanner data in the resulting representation space; and (iv) utilizing the clustering outcomes as “signatures” that can be used to detect structural changes in the data using techniques from optimal mass transport.

In further embodiments, an example system can characterize network scanners through the use of low-dimensional embeddings acquired via deep autoencoders. The example system can employ an array of features to profile the behavior of each scanner, and can pass the set of feature-rich scanners to an unsupervised clustering method. The output of clustering can be a grouping of the scanners into a number of classes based on their scanning profiles. Then, these clustering outputs can be used as input to a change-point detection framework based on optimal mass transport to identify changes in the Darknet data's behavior. As one example of an implementation utilized by the inventors in their experiments, the example system described above was deployed via Merit Network's large network telescope, and its ability to extract high-impact Darknet events in an automated manner was demonstrated.

In even further embodiments, an example system can receive unstructured, raw packet data (e.g., data collected from a network telescope), identify all scanning IPs within a monitoring interval of interest, annotate these scanners with external data sources such as routing, DNS, geolocation and data from Censys.io, distill an array of features to profile the behavior of each scanner, and pass the set of feature-rich scanners to an unsupervised clustering method. The output of clustering can be a grouping of the scanners into multiple clusters based on their scanning profiles.

While reference has been made herein to “Darknet” data or network telescope data (e.g., obtained from network telescopes), many of the same challenges are present in other scenarios in which scanner data is detected. For example, firewalls may detect Internet Background Radiation and provide the same types of data as a network telescope. Thus, the systems and methods discussed below for detecting and characterizing network scanner activity through use of Darknet data can equally apply to any other form of “scanner data”, such as from firewall detections.

Systems and methods herein employ deep neural networks (DNN) to perform “representation learning” methods (otherwise referred to as “embedding”) to automate the construction of low-dimensional vector space representations of heterogeneous, complex, high-dimensional network scanner data. Clustering methods, e.g., K-means, can then be applied to the resulting information-preserving embeddings of the data. Example systems can be evaluated using a few well-known packet-level signatures to validate and assess performance, including patterns attributed to known malware such as Mirai or popular network scanning tools used in cybersecurity research. The resulting clusters are analyzed to gain useful insights into the workings of the different network scanners. Such analyses can then be used to inform countermeasures against such cyber-attacks.

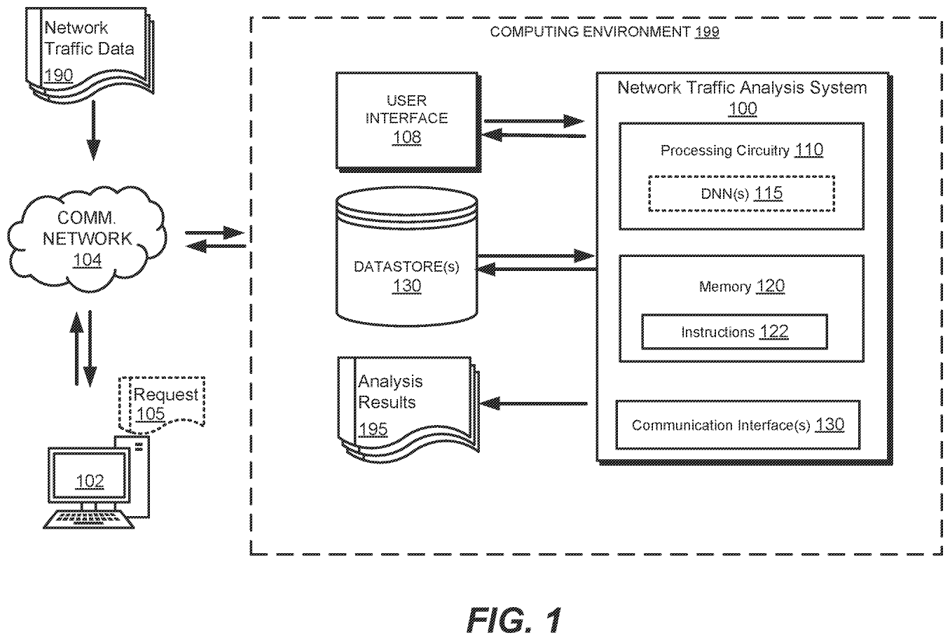

Referring now to FIG. 1, a non-limiting example of a hardware environment is shown, through which various methods and techniques described herein may be practiced. A Network Traffic Analysis system 100 includes at least one processor 110 (which may be a cloud resource or virtual machine), memory 120 coupled to the processing circuitry (which may be local to, or remote from the processor, and can be a cloud memory), and at least one communication interface 130 coupled to the processing circuitry 110. In some embodiments, given the size of the data sets to be processed, the processor 110 and memory 120 are cloud-based. The memory 120 stores machine-readable instructions which, when executed by the processing circuitry 110, are configured to cause the computing system 100 to perform methods disclosed herein, including implementing various deep neural networks 115.

The system 100 may also be coupled with a datastore 130, in which scanner data is stored. The datastore 130 may alternatively be, or be linked to, a remote repository of scanner data or network traffic data 190 provided by a third party via a remote connection 104. Network traffic data repository 190 may comprise a network telescope. The system 100 may also have a dedicated memory 195 that stores analysis results. These results can be used by the operator of the system 100 or made available to third parties such as customers, cybersecurity analysts, etc. To this end, the system 100 may also interact with a user interface 108, which may provide access to the analysis results 195 for third parties and/or access to the system 100 itself for the system operator. For example, in one embodiment, the computing environment 199 may be operated as a service that identifies scanner characteristics and behavior, identifies infected machines that may be operating as scanners, and provides insights on scanner trends. Thus, the environment 199 may be linked via a communication network 104 (which may be an Internet connection or a local connection) to one or more client computers 102 that may submit requests 105 for access to network telescope insights.

It will be appreciated that FIG. 1 shows a non-limiting example of a system suitable for performing methods disclosed herein. Other non-limiting examples may include any suitable combination of hardware, firmware, or software

### Example: Network Telescope Data

Network telescopes offer a unique vantage point into macroscopic Internet-wide activities. Specifically, they offer the ability to detect a broad range of dubious scanning activities; from high-intensity scanning to low-speed, seemingly innocuous nefarious behaviors, which are much harder to detect in a large-scale operational network. Typical approaches to detecting scanning in an operational network set a (somewhat arbitrary) threshold on the number of packets received from a suspicious host within a time period or a threshold on the number of unique destinations contacted by the host (e.g., 25 unique destinations with 5 minutes) as the detection criterion for suspected malicious behaviors. While this approach can indeed catch some dubious activities, it fails to capture those that occur at a frequency that is below the set threshold. On the other hand, lowering the threshold would inevitably include many more non-malicious events, hence overwhelming the analysts (i.e., high-alert “fatigue”) and significantly increase the complexity of further analyses aiming at distinguishing malicious events from normal ones. Because benign real-user network traffic does not reach the Darknet, scanning activities gathered at the network telescope do not need to be filtered, thus obviating the need to set an arbitrary threshold. Hence, even low-speed malicious activities can be easily detected in a network telescope that is sufficiently large.

In one experiment, a network telescope was used that monitors traffic destined to a /13 network address block, which is equivalent to about 500,000 IPv4 addresses. Formally, the time it takes to observe at least one packet from a scanner via a network telescope is related to three factors: 1) the rate of the scanning r, 2) the duration of a monitoring window T, and 3) the probability p that a packet hits the Darknet which corresponds to the fraction of IPv4 space monitored by the network telescope (p=1/8192 in the example case in this disclosure). Denoting with Z the probability of observing a packet in the Darknet within T seconds, the equation is:

$$Z = 1 - {( 1 - p )}^{rT} . \qquad ( 1 )$$

Solving for T the waiting time needed to observe a packet from a scanner with rate r at a certain probability level Z, can be obtained:

$${T}_{waiting} = \frac{1}{r * {log}_{1 - z} ( 1 - p )} \qquad ( 2 )$$

The elapsed times needed to detect several levels of scanning activities in a /13 network telescope are summarized in Table 1:

TABLE I

| Scanning Rate | Probability | Time to | |
|---|---|---|---|
| (pps) | (Z) | Detect | |
| 1000 | 0.95 | 25 | sec |
| 500 | 0.95 | 49 | sec |
| 125 | 0.95 | 3 | min |
| 50 | 0.95 | 8 | min |
| 10 | 0.90 | 31 | min |
| 1 | 0.90 | 314 | min |
| 1 | 0.33 | 54 | min |

### Example: Problem Formulation

Network telescopes provide the unique opportunity to observe Internet-wide inconspicuous events. An example framework in the present disclosure can analyze and process in near-real-time the vast amount of Darknet events that are captured in large network telescopes. Hence, the example frame can enhance the situational awareness regarding ongoing cyber-threats. To achieve this, the following problems can be tackled.

Example Problem 1: Network Telescope Clustering. In some examples, N scanners observed in Darknet can exist, and each scanner can be characterized by a high-dimensional feature vector x∈ [symbol] . In this disclosure, features can be compiled on a daily basis (e.g., total number of packets a scanner has sent within a given day). In further examples, an example system in the disclosure can assign the scanners into K groups such that “similar” scanners are classified in the same group. The notion of similarity can be based on the “loss function” employed to solve the clustering problem.

Problem 2: Temporal Change-point Detection. In some examples, the clustering assignment matrices M₀ and M₁ can exist, where the clustering assignment matrices M₀ and M₁ denoting the clustering outcomes for day-0 and day-1, respectively. Here, Mₜ∈{0, 1}^{N×K} can be a binary matrix that denotes the cluster assignment for all N scanners, i.e., Mₜ1_{K}=1_{N} for t∈{0, 1}, where 1_{K} and 1_{N} are column vectors of ones of dimension K and N, respectively 1. The example system can detect significant changes between the clustering outcomes M₀ and M₁ that would denote that the Darknet structure changed between day-0 and day-1. This problem can be cast as the problem of comparing two multi-variate distributions based on optimal mass transport.

Henceforth, it can be assumed that day-0 and day-1 are adjacent days, and thus the system can detect significant temporal Darknet structure shifts amongst consecutive daily intervals. Notably, the same approach could be utilized to compare network telescopes across “space”, namely to assess how dissimilar two network telescopes that monitor different dark IP spaces might be. In some examples, the traffic that a network telescope receives is affected by the monitored IP space and the locality of the scanner.

### Example: Near-Real-Time Data Pipeline

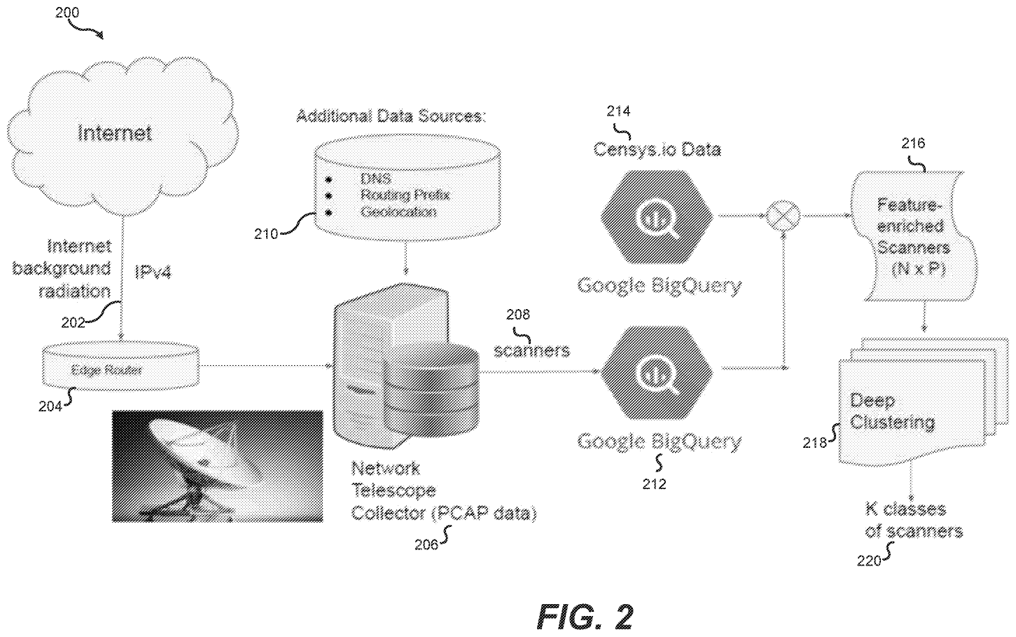

Next, with reference to FIG. 2, a sample network architecture 200 is described, and associated networking and processing instrumentation, for providing a near-realtime pipeline for extracting and annotating scanner data. Packets 202 arriving in the /13 dark IP space are collected in PCAP format on an hourly basis via an edge router 204 connected to a network telescope collector 206. During a typical day, more than 100 GB of compressed Darknet data is collected including some 3 billion packets on average. As FIG. 2 depicts, the raw material is processed post collection (i.e., after the hourly file is written on disk) and for every 10 minutes all scanners 208 are extracted and annotated with external data sources 210 such as DNS (using an efficient lookup tool such as zdns, as a nonlimiting example), geolocation information using the MaxMind databases and routing information from CAIDA's prefix-to-AS mapping dataset. The scanner data and additional data may be collected and stored at a memory associated with the network telescope collector 206.

The telescope may be programmed to identify and characterize scanners in several ways, using different criteria. For example, a scanner 208 can comprise as any host that has sent at least one TCP SYN, UDP or ICMP Echo Request packet in a network telescope; the system can record their source IP, the protocol and port scanned and other critical information useful for the partitioning task (described in further detail below). As Table I illustrates, even very low intensity scanners (e.g., scanning rates of 10 packets/sec) are captured with very high probability in the /13 network telescope within an hour. In some embodiments, a Darknet event is identified by i) the observed source IP, the ii) protocol flags used and iii) the targeted port. A system according to the teachings herein can employ caching to keep ongoing scanners and other events in memory. When an event remains inactive for a period of about 10 minutes, it “expires” from the cache and gets recorded to disk. Note here that scanners 208 that target multiple ports and/or protocols would be tracked in multiple separate events.

After the scanners 208 are identified they may be stored in a suitable database for efficient analysis, further processing and also ease of data sharing. In one embodiment, all identified Darknet events are also uploaded in near-real-time to Google's BigQuery 212 for efficient analysis, further processing and also ease of data sharing. In addition, storing the extracted events into BigQuery tables enables easy integration with extra data sources also available in BigQuery, namely Censys.io data 214. In addition, storing the extracted scanning events into database structures (including, as non-limiting examples, key-value stores, SQL databases, NoSQL databases, etc.) enables easy integration with other data sources, including Censys.io data 214, as one non-limiting example. Censys actively scans the whole IPv4 space and their data provide a unique perspective on the nature of a scanner since they potentially include information about the open ports and services at the scanning host itself. As discussed below, such coupling of information can allow identification of device types and manufacturer information of devices infected by Malware (e.g., devices infected by the Mirai malware). In some examples. Censys data 214 is used in in a similar manner to enrich the scanner features used for clustering tasks 218.

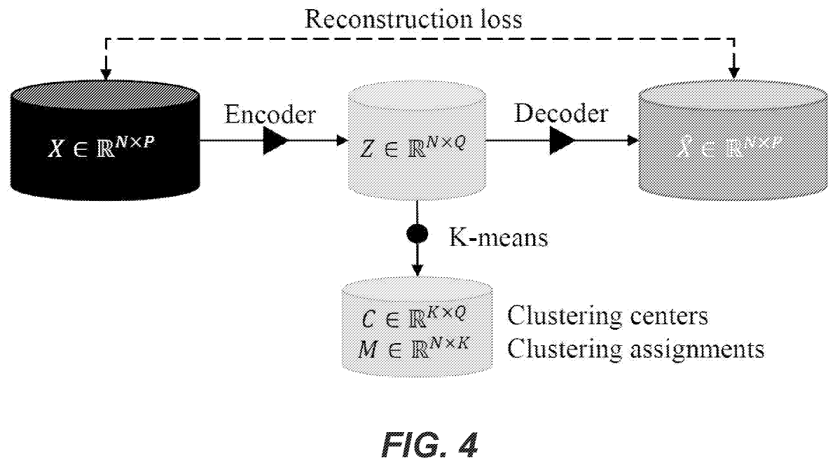

The pipeline then sends the compiled data to a processing stage, at which a clustering step (see also FIG. 4, described further below) is performed; the deep representation learning plus K-means module receives as input a matrix of N scanners with p features 216, described further below, and outputs K clusters of scanner 220.

### Example Clustering Methods

There are at least two challenges in identifying and characterizing malware behaviors in a large Darknet through clustering. First, the dimensionality of the feature space is very high (i.e., in the order of thousands). Second, the evaluation and interpretation of the clustering results of scanners could be challenging because there may be no “ground truth” or clustering labels. One therefore needs to use semantics extracted from the data itself. Accordingly, several systems and methods designed to address these challenges are described below, including the engineered features, and approach for addressing the high dimensionality challenges through a combination of (1) one-hot encoding of high-dimensional features (e.g., ports), and (2) deep learning for extracting a low-dimension latent representation.

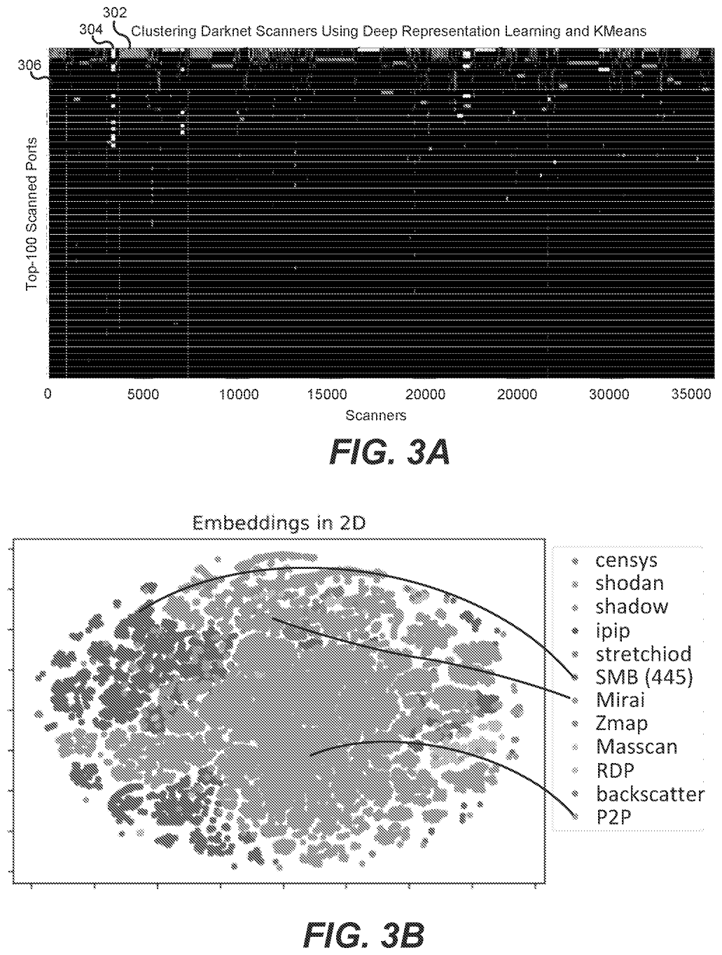

FIG. 3A shows an example Clustering outcome using deep representation learning (via an autoencoder) followed by K-means. Clustering boundaries are omitted to avoid clutter; one can easily identify though many of the important partitions formed. Results depicted are for the hour of Apr. 10, 2020 1200 UTC. The image in FIG. 3A shows the set of ports scanned by all scanners in this dataset. Grey shaded pixels 302 indicate activity on a port by the corresponding scanner, white pixels 304 indicate activity associated with a Mirai-related scanner and black pixels 306 indicate no activity at all. Results are demonstrated here for the top-100 scanned ports. In the example Clustering outcome, the grey vertical stripes 302 that highlight high-intensity scanners, aggressively scanning a large number of ports. Notice also the different Mirai families targeting a wide range of insecure ports.

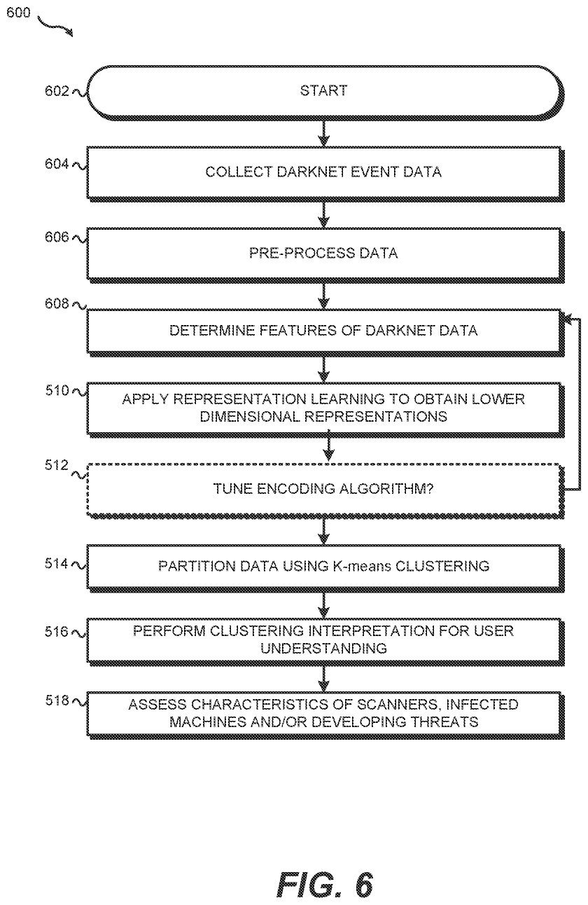

As can be seen, FIG. 3B illustrates how a proposed approach can “learn” meaningful features and map them into a low-dimension latent space, while keeping representations of similar points close together in the latent space. These low-dimension embeddings can then be passed as input to a clustering method, such as a K-means clustering algorithm (e.g., as shown in FIG. 6) to get the sought clusters. In the example shown, a t-SNE method was used to project in 2D the latent space of dimension d=50 learned by a multi-layer perceptron autoencoder when applied on a set of about 330,000 Darknet events captured on Jan. 9, 2021.

In one embodiment, scanners are extracted in a near-real-time manner every 10 minutes. For clustering purposes, in such an embodiment, the system can aggregate their features over a wider time interval (some embodiments may use a monitoring interval of 60 minutes). For example, for any scanner identified in the 1-hour interval of interest, a system implementing the techniques disclosed herein can record all of the different ports scanned, tally all packets and bytes sent, etc. In some examples, several features used are extremely high-dimensional; e.g., the number of unique TCP/UDP ports is 2¹⁶ and the total number of routing prefixes in the global BGP ecosystem approaches 1 million. Therefore, in one example, a one-hot encoding scheme for these high-dimensional features where only the top n values (ranked according to packet volume) of each feature are encoded during the hour of interest is used. Meanwhile, as explained further below, thermometer encodings may be used in other examples. A clustering result using Deep Representation Learning and K-means and thermometer encoding of numerical features, for example, is shown in FIG. 3A.

A deep autoencoder can convert the input data into a clustering friendly, low-dimensional representation space and then a clustering algorithm can be applied on the representation space. The workflow is shown in FIG. 4. The deep clustering approach can be divided into two phases: representation learning and clustering. These phases are described in detail below.

In some examples, the input data can be converted to a desired representation space that is low-dimensional, clustering friendly and preserve the information of the input data as much as possible. Specifically, the autoencoder framework can be exploited. Let e_{θ} be a nonlinear encoder function parameterized by θ that maps the input data to a representation space, and dγ(⋅) be a nonlinear decoder function parameterized by γ that maps the data points from the representation space to the input space, such that:

$${e}_{θ} ( {x}_{i} ) = f ( {x}_{i} , θ ) {=}^{△} {z}_{i} , f ( : , θ ) : \to$$

$${d}_{γ} ( {x}_{i} ) = f ( {z}_{i} , γ ) {=}^{△} {\hat{x}}_{i} , f ( : , γ ) : \to$$

Examples of systems and methods herein use DNN as the implementation of both mapping functions ƒ(:,θ) and ƒ(:, γ). In order to learn representations that preserve the information of the input data, minimizing the reconstruction loss con be considered, given by:

$${min}_{θ , γ} ( {\sum }_{i = 1}^{N} [ ℓ ( g ∘ f ( {x}_{i} ) , {x}_{i} ) ] + λ [ R ( θ ) + R ( γ ) ] ) \qquad ( 3 )$$

where [symbol] (⋅): [symbol] → [symbol] is a loss function that quantifies the reconstruction error. For simplicity, the sum-of-squares distance [symbol] (x,y)=∥x−y∥₂² can be chosen. R(⋅) is a regularization term for the model parameter. The [symbol] ₂ norm is used, such that R(θ)=∥θ∥₂². λ≥0 is the regularization coefficient. All model parameters (i.e., {θ, γ}) can be jointly learned using gradient-based optimization methods (e.g., adam).

The performance of deep learning models can be improved by enforcing pre-training. In some examples, the greedy layer-wise pre-training can be utilized because it breaks the deep network into shallow pieces that are easier to optimize, thus helping to avoid the notorious vanishing gradient problem and provide good initial parameters for the actual training of the full network. Assuming a mirror network structure for the encoder and decoder networks, the greedy layer-wise unsupervised pre-training works as follows. Let e^{(l)} be the l-th layer of the encoder network (l=1, . . . , L). The corresponding decoder layer is d^{(L-l)}. The model can start by constructing a shallow encoder and decoder network by first using only e⁽⁰⁾∪e⁽⁰⁾ and d^{(L-1)}∪d^{(L)}. This shallow autoencoder can be optimized using the training data for 10 iterations. Then, at the i-th step (i=2, . . . , L), the i-th layer can be added to the existing encoder and the (L−i)-th layer to the existing decoder, forming an encoder ∪ₗ₌₀ⁱ e^{(l)} and a decoder ∪_{l=L-i}^{L} d^{(l)}. During each step, the current autoencoder can be optimized using the training data for 10 iterations. The learning rate can be gradually reduced at each step by a factor of 0.1. As i approaches L, all the layers can be included, and the structure of both encoder and decoder networks can be completed. After the pre-training, all the learned parameters can be preserved, and the learned parameters can be used as initial values for the actual autoencoder training.

Representation learning yields low-dimensional information, preserving a rich encoding of the high-dimensional data from the scanners. Thus, clustering can now be performed on the encoding. Several alternatives are available to use as the clustering method to be applied to the resulting low-dimensional encoding. As discussed below, in several experiments K-means clustering method demonstrated the best performance when compared with competing approaches for the task at hand. Hence, in some embodiments, a partitioning step is based on K-means. Some embodiments perform K-means clustering directly on the low-dimensional representation of the data. Formally, in this step, some embodiments aim to minimize the following clustering loss:

$${min}_{θ , γ} {\sum }_{i = 1}^{N} [ ℓ ( g ∘ f ( {x}_{i} ) , {x}_{i} ) ] + λ [ R ( θ ) + R ( γ ) ] \qquad ( 4 )$$

$$such that {m}_{i , j} ∈ \{ 0 , 1 \} and M {1}_{K} = {1}_{N}$$

where M is the clustering assignment matrix, the entries of which are all binary. C is the matrix of clustering centers that lie in the representation space. 1K is a K-dimensional column vector of ones. The most widely-used algorithm for solving (4) involves an EM procedure. That is, in the E step, C can be fixed, and M can be computed by greedily assigning data points to their closest center; while in the M step, M can be fixed, and C can be computed by averaging the features of the data points allocated to the corresponding centers. The complete algorithm works by alternating between and E and M steps until convergence, i.e., reaching a maximum number of iterations or the optimization improvement between two consecutive iterations falls below a user-controlled threshold.

### Example Network Telescope Features

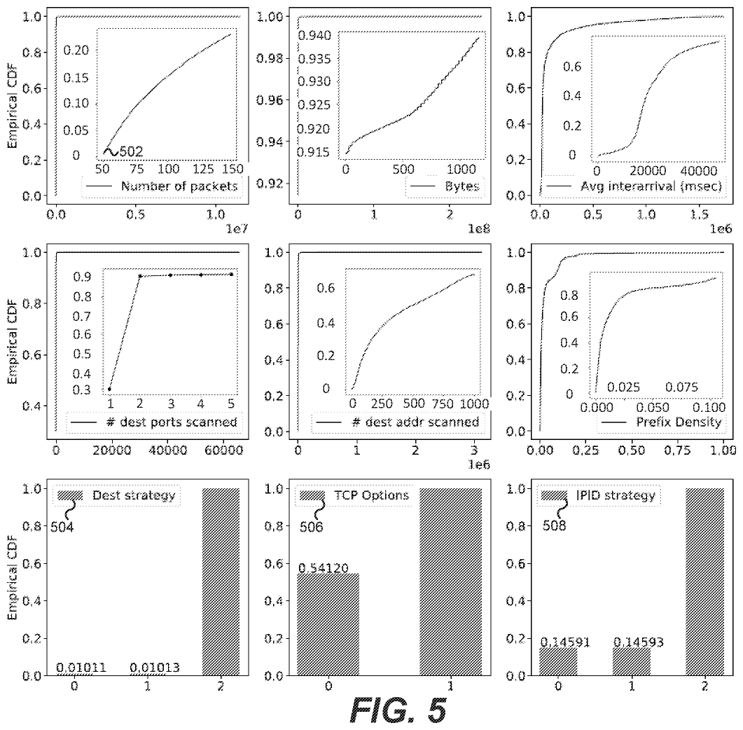

In some examples, an array of numerical and categorical features can be utilized to characterize network telescope scanners. FIG. 5 shows exemplar empirical cumulative distribution functions (CDFs) for the numerical features that characterize scanning activity. The data source in FIG. 5 is data on Sep. 14, 2016 from Merit's network telescope. The features shown are compiled for the filtered scanners of Sep. 14, 2016 (see Table II). The CDFs illustrate the richness and complexity of the Darknet ecosystem in terms of traffic volume received from senders (e.g., see packets, bytes and average inter-arrival time), scanning strategy (e.g., see number of distinct destination ports and number of distinct destination addresses scanned), etc. Each of the example features (not limited to the features shown below) is described below.

TABLE II
Traffic Types

| | Fraction of Scanners |
|---|---|
| Traffic Type | (%) |
| TCP-SYN | 91.17 |
| TCP-SYN, UDP | 4.04 |
| UDP | 2.48 |
| ICMP Echo Request | 0.61 |
| TCP-SYN, UDP, ICMP Dest. Unreachable | 0.47 |

Traffic volume. A series of features can characterize the volume and frequency of scanning, namely total number of packets transmitted within the observation window (i.e., a day), total bytes and average inter-arrival time between sent packets. The large spectrum of values that these features exhibit can be observed. For instance, FIG. 5 shows that some scanners send only a few packets (i.e., as low as 50 packets, an example lower bound 502 for filtered traffic) while some emit tens of millions of packets in the network telescope, aggressively foraging for Internet victims.

Scan strategy. Features such as number of distinct destination ports and number of distinct destination addresses scanned within a day, prefix density, destination strategy, IPID strategy and IPID options reveal information about one's scanning strategy. For instance, some senders can be seen to only focus on a small set of ports (about 90% of the scanners on September 14th targeted up to two ports) while others target all possible ports. Prefix density is defined as the ratio of the number of scanners within a routing prefix over the total IPs covered by the prefix (e.g., CAIDA's pf2as dataset for mapping IPs to their routing prefix), and can provide information about coordinated scanning within a network. Destination strategy 504 and IPID strategy 508 can be features that show 1) whether the scanner kept the associated fields (i.e., destination IP and IPID) constant, 2) with fixed increments or 3) were kept random. Based on destination strategy and IPID strategy, the scanning intentions and/or tools used for scanning (e.g., the ZMap tool using a constant IPID of 54321) can be known. TCP options 506 is a binary feature that illustrates whether any TCP options have been set in TCP-related scanning. In a non-limiting scenarios, the lack of TCP options can be associated with “irregular scanning” (usually associated with heavy, oftentimes nefarious, scanning). Thus, the irregular scanning can be tracked as part of the example features.

Targeted applications. Example features can include a set of ports and set of protocol request types scanned to glean information about the services being targeted. Since there are 516 distinct ports, encoded in an example—using the one-hot-encoding scheme—the set of ports scanned using the top-500 ports identified on Sep. 2, 2016. In some examples, if a scanner had scanned ports outside the top-500 set, its one-hot-encoded feature for ports can be all zeros. Table 11 shows the 5 example protocol types (top-5 for Sep. 2, 2016) that are also encoded using a one-hot-encoding scheme.

Device or scanner type. In some examples, the set of TTL values seen per scanner can be used as an indicator for “irregular scan traffic,” and/or the device OS type. For instance, IoT devices that usually run on Linux/Unix-based OSes can be seen with TTL values within the range 40-60 (the starting TTL value for Linux/Unix OSes is 64). On the other hand, devices with Windows can be seen scanning the network telescope with values in the range 100-120 (starting value for Windows OSes is 128).

### Example Change-Point Detection Methods

The clustering outcomes obtained can be utilized both for characterizing the Darknet activities within a monitoring window (e.g., a full day) and for detecting temporal changes in the Darknet's structure (e.g., the appearance of a new cluster associated with previously unseen scanning activities). To accomplish the latter, examples techniques can be employed from the theory of optimal transport also known as Earth mover's distance. An example change-point detection approach is described next, after first introducing the desirable mathematical formulations.

Optimal Transport: Optimal transport can serve several applications in image retrieval, image representation, image restoration, etc. Its ability to “compare distributions” (e.g., comparing two images) can be used to “compare clustering outcomes” between days.

Let I₀ and I₁ denote probability density functions (PDFs) defined over spaces Ω₀ and Ω₁, respectively. Typically, Ω₀ and Ω₁ are subspaces in [symbol] . In the Kantorovich formulation of the optimal transport problem, a transport plan can “transform” I₀ to I₁. The plan, denoted with function γ, can be seen as a joint probability distribution of I₀ and I₁ and the quantity γ (A×B) describes how much mass in set A∈Ω₀ is transported to set B∈Ω₁. In the Kantorovich formulation, the transport plan γ can (i) meet the constraints γ/(Ω₀×B)=I₁(B) and γ/(A×Ω₁)=I₀(A), where I₀(A)=∫_{A}I₀(x)dx and I₁(B)=∫_{B}I₁(x)dx and (ii) minimize the following quantity:

$${min}_{γ} {\int }_{{Ω}_{0} \times {Ω}_{1}} c ( x , y ) d γ ( x , y ) ,$$

for some cost function c: Ω₀×Ω₁→ [symbol] that represents the cost of moving a unit of mass from x to y.

Application to Darknet clustering. In the Darknet clustering setting, the inventors consider the discrete version of the Kantorovich formulation. The PDFs I₀ and I₁ can now be expressed as I₀=Σᵢ₌₁^{K}pᵢδ(x−xᵢ) and I₁=Σⱼ₌₁^{K}qⱼδ(y−yⱼ), both defined over the same space Ω, where δ(x) is the Dirac delta function. The optimal transport plan problem now becomes

$$K ( {I}_{0} , {I}_{1} ) = {min}_{γ} {\sum }_{i} {\sum }_{j} c ( {x}_{i} {y}_{j} ) {γ}_{ij} \qquad ( 3 )$$

$$s . t . {\sum }_{j} {γ}_{ij} = {p}_{i} , {\sum }_{i} {γ}_{ij} = {q}_{j}$$

$${γ}_{ij} \geq 0 , i , j = 1 … , K .$$

Solutions to this problem can be obtained using linear programming methods. Further, when the cost function is c(x,y)=|x−y|^{p}, p≥1, the optimal solution of (3) defines a metric on P(Ω), i.e., the set of probability densities supported on space Ω. This metric is known as p-Wasserstein distance and can be defined as

$${W}_{p} ( {I}_{0} , {I}_{1} ) = {\sum }_{x} {\sum }_{j} {\vert {x}_{i} - {y}_{j} \vert}^{p} {γ}_{ij}^{* \frac{1}{p}} \qquad ( 4 )$$

where γ* is the optimal transport plan for (3).

The example approach herein can employ the 2-Wassertein distance on the distributions I₀ and I₁ that capture the clustering outcomes M₀, M₁, where Mᵤ, u=0, 1, are the clustering assignment matrices for two adjacent days. Let X₀ and X₁ denote the N×P matrices that represent the scanner features for the two monitoring window. Define:

$${D}_{u} = {M}_{u}^{⊤} {1}_{N} \qquad ( 5 )$$

$${C}_{u} = ( {X}_{u}^{⊤} {M}_{u} ) diag ( {D}_{u}^{- 1} ) , u = 0 , 1.$$

Namely, the i-th entry of vector D, denotes the cluster size of the i-th cluster of scanners identified for day-u, and the i-th row of matrix C can represent the clustering center of cluster i. Hence, the weights and Dirac locations for the discrete distributions I₀=Σᵢ₌₁^{K}pᵢδ(x−xᵢ) and I₁=Σⱼ₌₁^{K}qⱼδ(y−yⱼ) can be readily available; i.e., the weight pᵢ for cluster i of day-0 corresponds to the size of that cluster normalized by the total number of scanners for that day, and location xᵢ corresponds to the center of duster i. Thus, one can obtain the distance W₂(I₀,I₁) and optimal plan γ* by solving the minimization shown in (3).

In some examples, one can utilize distance W₂(I₀, I₁) and the associated optimal plan γ* to (i) detect and (ii) interpret clustering changes between consecutive monitoring windows. Specifically, an alert that signifies a change in the clustering structure can be triggered when the distance W₂(I₀, I₁) is “large enough”. There is no test statistic for the multivariate “goodness-of-fit” problem. Thus, detecting anomalies can be detected via the use of historical empirical values of the W₂(I₀, I₁) metric that one can collect. When an alert is flagged, the optimal plan γ* can be leveraged to shed light into the clustering change.

FIG. 6 is a flowchart illustrating an example method 600 for processing network telescope scanner data according to some of the features and techniques described herein. The process 600 may start 602 via initiation of a system such as disclosed in FIG. 1.

At step 604, Darknet event data is collected. In some examples. Darknet data (i.e., Darknet event data) associated with scanning activities of multiple scanners can be received. As described above, this data can be acquired from a remote source, or a local source such as a network telescope. In some examples, network telescopes, also known as “Darknets”, provide a unique opportunity for characterizing and detecting Internet-wide malicious activities. A network telescope receives and records unsolicited traffic—known as Internet Background Radiation (IBR)—destined to an unused but routed address space. This “dark IP space” hosts no services, and therefore any traffic arriving to it is inherently malicious. No regular user traffic reaches the Darknet. In some examples, the Darknet or network telescope is a tool (including networking instrumentation and servers and storage) used to capture Internet-wide scanning activities destined to “dark”/unused IP spaces. Traffic destined to unused IP spaces (i.e., dark IP space) could be referred as Darknet traffic or “Internet Background Radiation”.

At step 606, data may then be pre-processed, such as to group scanning events by scanner, to combine scanner data with additional data (e.g., DNS and geolocation), or to filter the events to include only top or most relevant scanners.

Next at step 608, certain features of the Darknet data are determined for use in the deep clustering phase. In some embodiments, this may include the features of Table Ill. In one embodiment, only the following features are used: total packets, totally bytes, total lifetime, number of ports scanned, average lifetime, average packet size, set of protocols scanned, set of ports scanned, unique destinations, unique /24 prefixes, set of open ports at the scanner, and scanner's tags.

In some embodiments, multiple sets of features corresponding to the multiple scanners can be determined based on the Darknet data. In further embodiments, a set of features can correspond to a scanner, and the scanning activities of the multiple scanners can be within a predetermined period of time. In a non-limiting example, the predetermined period of time can be a day, two days, a month, a year, or any other suitable time period to detect malicious activities in the network. In further embodiments, the set of features can include at least one of: a traffic volume, a scanning scheme, a targeted application, or a scanner type of the scanner. In some scenarios, the traffic volume of the scanner within the predetermined period of time can include at least one of a total number of packets transmitted, a total amount of bytes transmitted, or an average inter-arrival time between packets transmitted. In further scenarios, the scanning scheme within the predetermined period of time can include at least one of: a number of distinct destination ports, a number of distinct destination addresses, a prefix destiny, or a destination scheme. In even further scenarios, the targeted application within the predetermined period of time can include at least one of, a set of ports scanned, or a set of protocol request types scanned. In even still further scenarios, the scanner type of the scanner within the predetermined period of time can include at least one of: a set of time-to-live (TTL) values of the scanner, or a device operating system (OS) type. In some examples, the multiple sets of features can include heterogeneous data containing at least one categorical dataset for a feature and at least one numerical dataset for the feature.

Next, at step 610, a deep representation learning method may be applied, in order to obtain a lower dimensional representation or embedding of the network telescope features. In some examples, high dimensional data may indicate the number of features is more than the number of observations. In other examples, the difference between high-dimensional and low-dimensional representation can be quantified by data “compression” (i.e., compressing one high-dimensional vector (e.g., dimension 500) to a lower-dimensional representation (e.g., dimension 50)); this is what the autoencoder does in the present disclosure, namely compressing the input data/features onto a lower dimensional space while also “preserving” the information therein, method may include use of a multi-layer perceptron autoencoder, or a thermometer encoding, or both, or similar encoding methods. For example, multiple embeddings can be generated based on a deep autoencoder. In some embodiments, the multiple embeddings can correspond to the multiple sets of features to reduce dimensionality of the plurality of sets of features. In some examples, the multiple sets of features can be projected onto a low-dimensional vector space of the multiple embeddings corresponding to the multiple sets of features. Here, the deep autoencoder can include a fully-connected multilayer perceptron neural network. In some embodiments, the fully-connected multilayer perceptron neural network can use two layers. In some examples, the deep autoencoder can be separately trained by minimizing a reconstruction loss based on the plurality of sets of features and the plurality of embeddings. In other examples, the deep autoencoder can be trained with the runtime data. For example, as shown in FIG. 4, the multiple sets of features can be encoded to the multiple embeddings. While the multiple embeddings can be used for clustering and detecting malicious activities, the multiple embeddings can be decoded to compare the decoded embeddings with the multiple sets of features to minimize a reconstruction loss. For example, multiple decoded input datasets can be generated by decoding the multiple embeddings to map the multiple decoded input datasets to the multiple sets of features. In some examples, the reconstruction loss can be minimized by minimizing distances between the multiple sets of features and the multiple decoded input datasets. The multiple sets of features can correspond to the multiple decoded input datasets.

Next, at step 612, the method may optionally assess the results of the deep representation learning, and determine whether the deep representation learning needs to be adjusted. For example, if an MLP approach was used, the system may attempt a thermometer encoding to assess whether better results are achieved. For example, a hyperparameter tuning may be used, as described herein. This step may be performed once each time a system is initialized, or it may be performed on a periodic basis during operation, or for each collection period of scanner data. If it is determined that any tuning or adjustment is needed, then the method may return to the feature determination step. If not, the method may proceed.

At step 614, a clustering method is performed on the results of the deep representation learning. For examples, multiple clusters can be generated based on the plurality of embeddings using a clustering technique. In some examples, the clustering technique can include a k-means clustering technique clustering the multiple embeddings into the multiple clusters (e.g., k clusters). In some examples, the number of the multiple clusters can be smaller than the number of the multiple embeddings. In further examples, the multiple clusters can include a first clustering assignment matrix and a second clustering assignment matrix. The first clustering assignment matrix and the second clustering assignment matrix being for adjacent time periods. However, it should be appreciated that the two clustering assignment matrices are mere examples. Any suitable number of clustering assignment matrices can be generated. In even further examples, a first probability density function capturing the first clustering assignment matrix can be generated, and a second probability density function capturing the second clustering assignment matrix can be generated. In one embodiment, this is performed as a K-means clustering as described herein. In other embodiments, other unsupervised deep learning methods may be used to categorize scanners and scanner data.

At step 616, the clustering results are interpreted. As described herein, this may be done using a variety of statistical techniques, including various decision trees. In one embodiment, an optimal decision tree approach may be used. The result of this step can be a decision tree, and/or descriptions of attributes of the clusters that were determined. In some examples, a temporal change can be detected in the plurality of clusters. For example, to detect the temporal change, an alert can be transmitted when a distance between the first probability density function and the second probability density function. In a non-limiting example, the distance can be a 2-Wasserstein distance on the first probability density function and the second probability density function.

At step 618, the result of the clustering interpretation is applied to create assessments of network telescope scanners. For example, the results can be summarized in narrative, list, or graphical format for user reports.

### Example: Performance Evaluation Metrics

Features and benefits of systems disclosed herein may be better understood by discussion of results produced by an example system implemented according to the methods disclosed herein. First, evaluation metrics used to assess the performance of unsupervised network telescope clustering systems and interpret clustering results are described. Using these metrics, the inventors undertook a plethora of clustering experiments to obtain insights on the following: By looking at competing methods such as K-means, K-medoids and DBSCAN, assess how each clustering algorithm is performing for the task at hand; (1) Illustrate the importance of dimensionality reduction and juxtapose the deep representation learning approach with Principal Component Analysis (PCA); (2) Examine the sensitivity of the deep autoencoder with respect to the various hyper-parameters (e.g., regularization weight, dropout probability, the choice of K or the dimension Q of the latent space).

In the absence of “ground truth” regarding clustering labels, a series of evaluation metrics can be defined to help assess the silhouette coefficient. The silhouette coefficient is frequently used for assessing the performance of unsupervised clustering algorithms. Clustering outcomes with “well defined” clusters (i.e., clusters that are tight and well-separated from peer clusters) get a higher silhouette coefficient score.

Formally, the silhouette coefficient is obtained as:

$$S C = \frac{b - a}{max \{ a , b \}}$$

where a is the average distance between a sample and all the other points in the same cluster and b is the average distance between a sample and all points in the next nearest cluster.

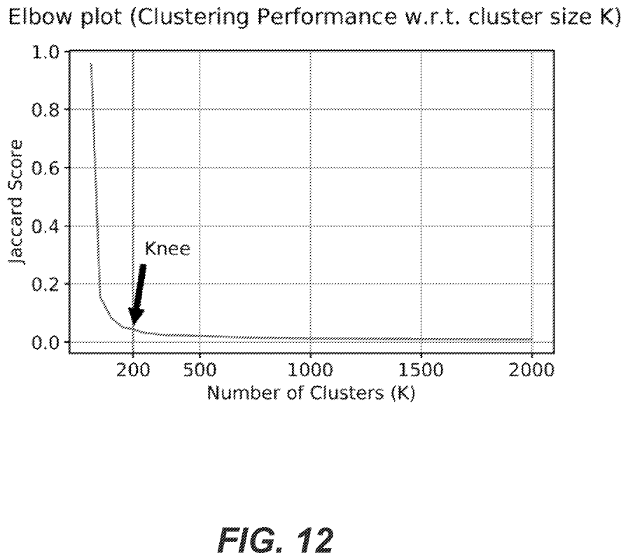

Another useful quality metric is a Jaccard score. The Jaccard index or Jaccard similarity coefficient is a commonly used distance metric to assess the similarity of two finite sets. It measures this similarity as the ratio of intersection and union of the sets. This metric is, thus, suitable for quantitative evaluation of the clustering outcomes. Given that there is a domain inspired predefined partitioning P={P₁, P₂, . . . , P_{S}} of the data, the distance or the Jaccard Score of the clustering result C={C₁, C₂, . . . , P_{N}} on the same data is computed as:

$$Jaccard = \frac{{M}_{11}}{{M}_{01} + {M}_{10} + {M}_{11}}$$

where M₁₁ is the total number of pair of points that belong to the same group in C as well as the same group in P, M₀₁ is the total number of pair of points that belong to the different groups in but to same group in P and M₁₀ is the total number of pair of points that belong to the same group in C but to different groups in P. This cluster evaluation metric incorporates domain knowledge (such as Mirai, Zmap and Masscan scanners, that can be identified by their representative packet header signatures, and other partitions as outlined earlier) and measures how compliant the clustering results are with the known partitions. Jaccard score decreases as the number of clusters used for clustering are increased. This decrease is drastic at the beginning and slows down eventually forming a “knee” (see FIG. 12, described further below). The “knee” where the significant local change in the metric occurs reveals the underlying number of groupings in the data.

Another useful metric is a Cluster Stability Score that quantifies cluster stability. This metric is important because it assesses how clustering results vary due to different sub sampling of the data. A clustering result that is not sensitive to sub-sampling, hence more stable, is certainly more desirable. In other words, the cluster structure uncovered by the clustering algorithm should be similar across different samples from the same data distribution. In order to analyze the stability of the clusters, multiple subsampling versions of the data can be generated by using bootstrap resampling. These samples are clustered individually using the same clustering algorithm. The cluster stability score is, then, the average of the pairwise distances between the clustering outcomes of two different subsamples. For each cluster from one bootstrap sample, its most similar cluster among clusters can be identified from another bootstrap sample using Jaccard index as the pairwise distance metric. In this case, the Jaccard index is simply the ratio of the intersection and union between the clusters. The average of these Jaccard scores across all pairs of samples provides a measure of how stable the clustering results are.

The inventors also devised metrics to help us interpret the results of clustering in terms of cluster “membership”. For instance, the inventors determined it would be helpful to understand whether the clustering algorithm was assigning scanners from the same malware family in the same class. Though there were no clustering labels for the scanners in the data; however, embodiments tested were able to compile a subset of labels by using the well-known Mirai signature as well as signatures of popular scanning tools such as Zmap or Masscan. Notably, training of the unsupervised clustering techniques was completely unaware of these labels: these labels were merely used for result interpretation.

The maximum coverage score can be defined as

$$M C = {max}_{i ∈ \{ 1 … K \}} [ max \{ {s}_{i}^{Mirai} , {s}_{i}^{Zmap} , {s}_{i}^{Masscan} \} ] \qquad ( 6 )$$

where sᵢ^{Mirai}, sᵢ^{zmap}, sᵢ^{masscan} are based on the fraction of Mirai, Zmap, and Masscan labels within the i-th cluster, respectively. To account for the cluster size, sᵢ^{Mirai} is defined as the harmonic mean of 1) the Mirai fraction in the i-th cluster and 2) the ratio of the i-th cluster's cardinality over the total number of scanners N. sᵢ^{zmap}, sᵢ^{masscan} are similarly defined. The maximum coverage score thus always lies between 0 and 1 with higher values interpreted as a better clustering outcome.

In further examples, the clusters can be interpreted according to the port(s) targeted by the scanners. Specifically, the information theoretic metric of the expected information gain or mutual information can be employed, defined as

$$IG ( P , a ) = H ( P ) - H ( P \vert a ) \qquad ( 7 )$$

where H(P) is the Shannon entropy with regard to the distribution of ports scanned in the whole dataset and H(P|a) is the conditional entropy of the port distribution given the cluster assignment a.

### Example: Performance Comparison

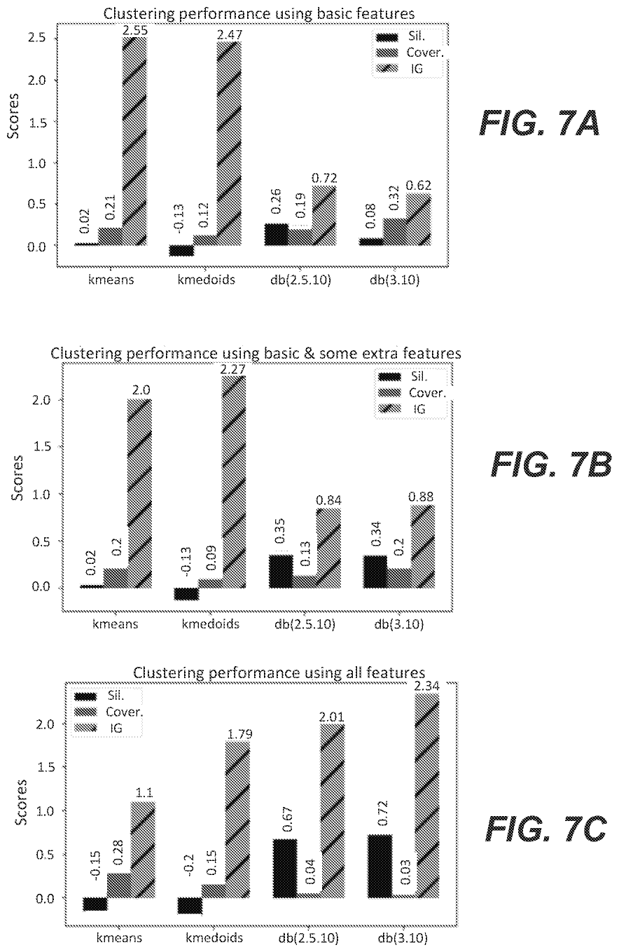

The panels in FIG. 7 show the performance of several clustering methods when different sets of network telescope features are existing clusters or not having enough points within their own neighborhood to form a new cluster). For instance, for the experiments of FIG. 7A the two DBSCAN methods left 17774 and 19051 unassigned data points (scanners), respectively. This suggests that DBSCAN-based clustering methods could be valuable in clustering network telescope data—perhaps in a stratified, two-step hierarchical approach.

FIG. 7 also suggests that K-medoids may not be suitable in all embodiments for various clustering tasks at hand. Some embodiments may employ K-medoids using the L1-distance metric to compute dissimilarities amongst data points: using the Manhattan distance on feature vectors that consist primarily of one-hot-encoded features (e.g., the set of ports scanned by a scanner, the protocols scanned, the services open as identified by Censys are all one-hot-encoded features; see Table III) could yield adequate clustering results. This is because L1-based dissimilarity metrics are well-suited for capturing set differences. Despite this, some K-medoids results indicated lower silhouette and maximum coverage scores than the ones obtained from the K-means methods.

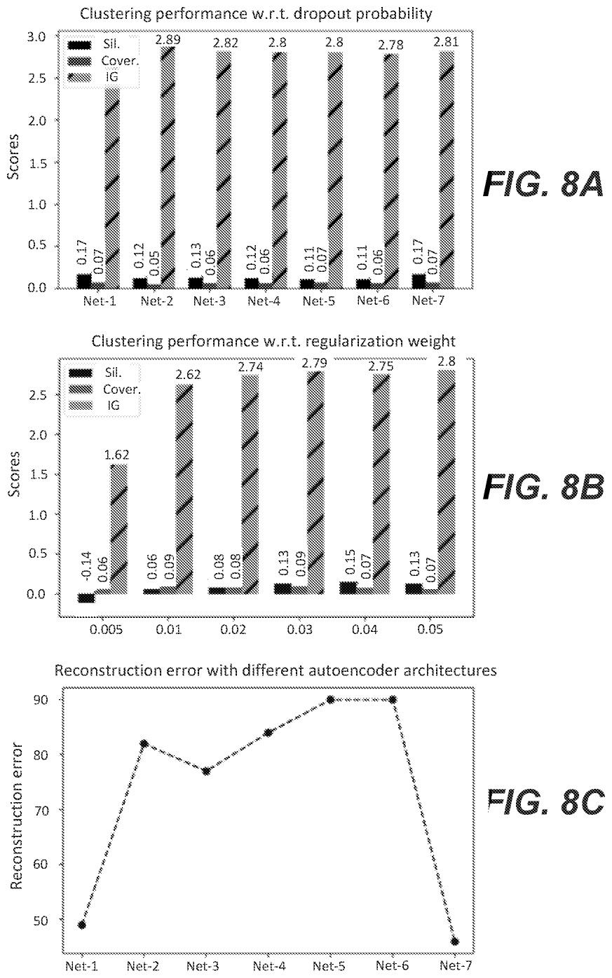

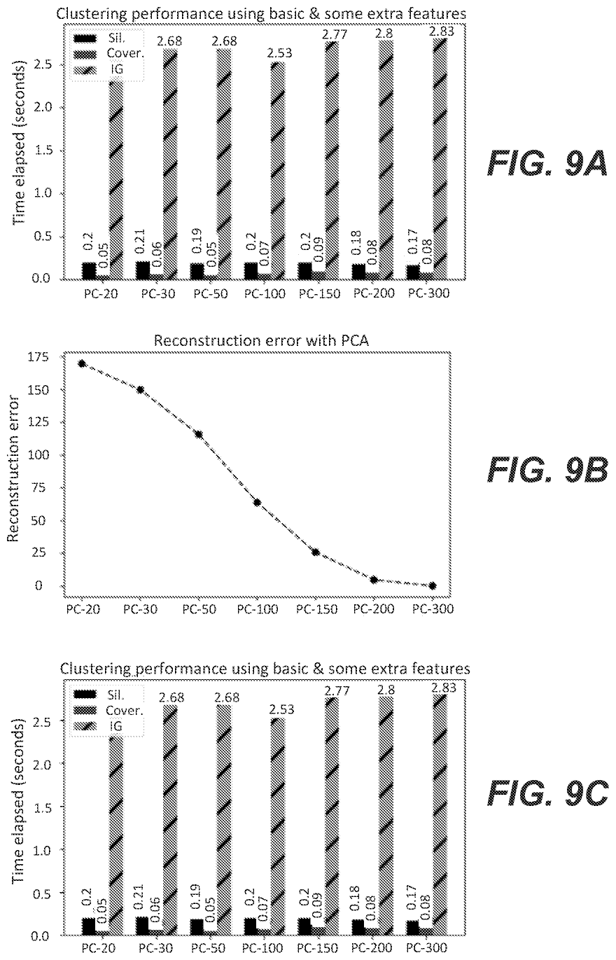

K-means performs relatively well with respect to all metrics; it exhibits high maximum coverage scores and showcases high information gain scores when employed on the “basic” and “enhanced” feature sets. Furthermore, FIGS. 8A and 9A indicate that simultaneously applying a dimensionality reduction method followed by K-means provides high-quality scores in all feature settings. This reiterates the importance of dimensionality reduction techniques in learning important latent features that can serve as input to subsequent clustering steps (see FIG. 5).

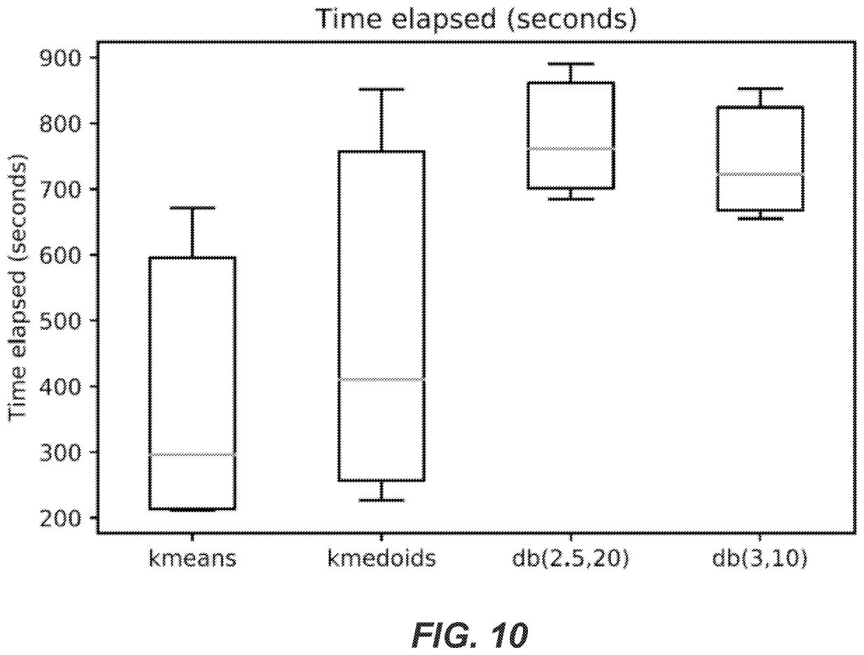

FIG. 8A displays the performance of deep learning with K-means, using the “enhanced” set of features (same dataset and settings as in FIG. 7B). The performance improvement in all three metrics is evident. In FIG. 8A the inventors test various network architectures, namely Net-1 with two hidden layers with 200 and 150 nodes; Net-2: with three hidden layers (200, 1000, and 150 nodes); Net-3 with three hidden layers (200, 500 and 150 nodes); Net-4: with three hidden layers (200, 300 and 150 nodes); Net-5 with three hidden layers (200, 200 and 150 nodes); Net-6 with three hidden layers (200, 200 and 100 nodes); and Net-7: with two hidden layers (200 nodes for each layer). FIG. 10 shows illustrates the computational advantages of K-means against its competitors.

The architectures “Net-1” and “Net-7” perform the best in terms of the metrics and, as shown in FIG. 9C, they exhibit the lowest reconstruction errors. Compared with various PCA alternatives of FIG. 9A, the inventors observe that “Net1” and “Net-7” yield almost always better performance in terms of the information gain criterion (meaning that their partitioning outcomes are more homogeneous with respect to the ports scanned) and perform competitively well on the other two measures.

Since a Deep Autoencoder behaves like PCA when the activation function chosen is linear, the inventors compare the results obtained using PCA and the deep Autoencoder. Specifically, the inventors juxtapose the reconstruction errors between the two techniques. FIG. 8C depicts the reconstruction errors of the encoder for the different architectures considered; they are on a par with the errors obtained with PCA for similar settings in FIG. 9B. This suggests that the interactions between the features of the scanner can be approximated by a linear model.

### Clustering of Autoencoded Data

The inventors now proceed with calibrating the proposed deep learning autoencoder plus K-means clustering approach. The sensitivity of the clustering outcome to the regularization coefficient l is illustrated in FIG. 8. Choosing l=0.05 for subsequent experiments since it seems to provide the best clustering outcomes (l=0.05 also provided adequate results).

The inventors also calibrated the following: 1) the batch size that denotes the amount of training data points used in each backpropagation step employed for calculating the gradient errors in the gradient descent optimization process (the inventors found a batch size of 512 to work well); 2) the learning rate used in gradient descent (a rate of 0.001 provided the best results); and 3) the number of optimization epochs (200 iterations are satisfactory).

Finally, in some embodiments, the ReLU activation function may be elected since it is a nonlinear function that allows complex relationships in the data to be learned while at the same time.

One challenge associated with encoding scanner profiles for representation learning is that a scanner profile includes, in addition to one-hot encoded binary features, numerical features (e.g., the number of ports scanned, the number of packets sent, etc.). Mixing these two types of features might be problematic because a distance measure designed for one type of feature (e.g., Euclidean distance for numerical feature, Hamming distance for binary features) might not be suitable for the other type. To test this hypothesis, the inventors also implemented an MLP network where all (numerical) input features are encoded as binary ones using thermometer encoding.

### Evaluation of an Example System

Below, performance of an example system for clustering Darknet data is evaluated. Numerical-valued Darknet data were encoding using a thermometer encoding. A simplified set of features, summarized in Table III below, were used.

TABLE III

| ID | Feature | Description |
|---|---|---|
| 1 | Total Packets | Aggregate number of packets sent in the |
| | | monitoring interval |
| 2 | Total Bytes | Aggregate number of bytes sent in the |
| | | monitoring interval |
| 3 | Total Lifetime | Total time span of scanning activity for |
| | | the scanner |
| 4 | Number of ports scanned | The number of unique ports scanned by |
| | | the scanner |
| 5 | Average Lifetime | The average time interval that a scanner |
| | | was active |
| 6 | Average Packet Size | The average packet size sent by a scanner |
| | | in the Darknet |
| 7 | Set of protocols scanned | One-hot-encoded set of all protocols |
| | | scanned by a scanner |
| 8 | Set of ports scanned | One-hot-encoded set of ports scanned by |
| | | a scanner |
| 9 | Unique Destinations | Min and Max number of Darknet hosts |
| | (Min, Max) | scanned |
| 10 | Unique/24 Prefixes | Min and Max number of Darknet/24 |
| | (Min, Max) | prefixes scanned |
| 11 | Set of open ports at | One-hot-encoded open ports/services at |
| | the scanner | the scanner per Censys.io |
| 12 | Scanner's tags | One-hot-encoded tags (extracted from |
| | (e.g., device type) | the scanner's banner, etc.) per Censys.io |

A Darknet dataset compiled for the day of Jan. 9, 2021, which includes about 2 million scanners, was used. As above, a number of cluster K=200 was chosen. A random sample of 500K scanners was used to perform 50 iterations of training autoencoders and k-means clustering, using 50K scanners in each iteration. The mean and standard deviation of the three clustering evaluation metrics, as well as the mean and standard deviation of the loss function (L2 for MLP, Hamming distance for thermometer-encoding-based MLP (TMLP)), are shown in Table IV, below.

TABLE IV

| Autoencoder | Loss | Silhouette | Jaccard | Stability |
|---|---|---|---|---|
| MLP | 0.96 (1.71) | 0.44 (0.01) | 0.043 (0.001) | 0.40 (0.007) |
| Thermom. | 24.97 (1.44) | 0.58 (0.02) | 0.012 (0.001) | 0.51 (0.008) |
| MLP | | | | |

The results indicated that the TMLP autoencoder led to better clustering results based on the silhouette and stability scores. However, a smaller Jaccard score was reported when compared to the MLP autoencoder. By inspecting the clusters generated, the inventors noticed that this is probably due to the fact that TMLP tended to group scanners into smaller clusters that are similar in size. I.e., it generated multiple fine-grained clusters that correspond to a common large external label used for external validity measure (i.e., the Jaccard score). Because the current Jaccard score computation does not take into account the hierarchical structure of external label, fine-grained partition of external labels are penalized, even though they can provide valuable characteristics of subgroups in a mal-ware family (e.g., Mirai). Henceforth, though, the inventors present results using the MLP architecture that scored very well on all metrics and provided more interpretable results.

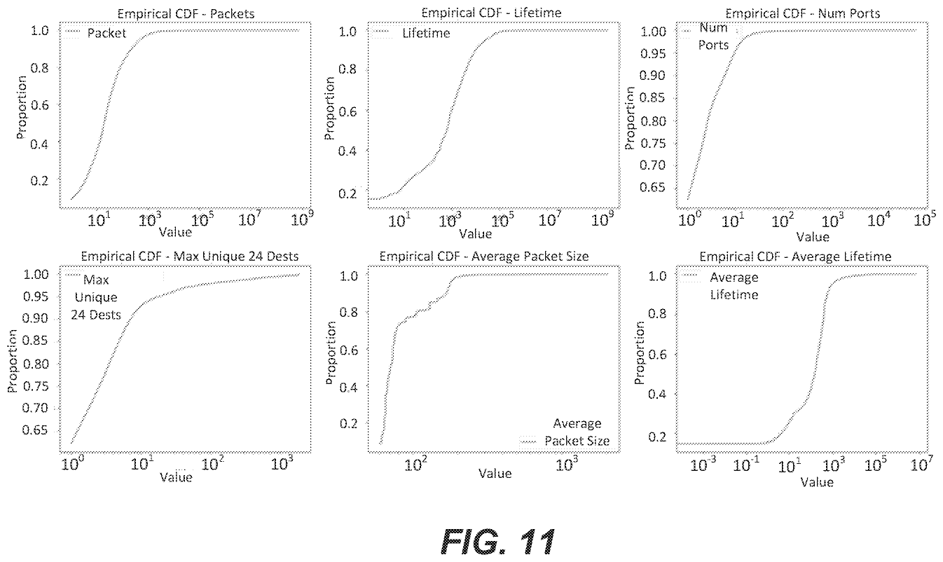

To construct the “bins” for the thermometer encoding, empirical distributions of numerical features compiled from a dataset ranging from Nov. 1, 2020 to Jan. 20, 2021 were used. These distributions are shown in FIG. 11. As depicted in FIG. 11, many features, such as the one for the number of ports scanned, exhibit a long-tail distribution. For instance, a very large percentage of scanners (about 70%) scan only 1 or 2 ports, while a very small percentage of scanners scan a huge number of ports. The latter group, while small in number, is of high interest to network analysts due to their aggressive scanning behaviors. Therefore, in some examples, log-based thermometer encoding is used to enables fine-grained partition of high intensity vertical scanners.

FIG. 12 examines performance vs the number of clusters K. It implies that K=200 or K=300 are good values for the number of clusters and the inventors have adopted K=200 in subsequent analyses. FIG. 9C performs sensitivity analysis with respect to the dropout probabilities: the dropout probability is used to avoid over-fitting. Dropping 10% or 20% of the network parameters to be learned showed positive outcomes.

### Interpretation and Internal Structure of Clusters

Clustering interpretation can be based on explanation of the clustering out-come to network analysts. Contrary to supervised learning tasks, there is no “correct” clustering assignment and the clustering out-come is a consequence of the features employed. Hence, it is germane to provide interpretable and simple rules that explain the clustering outcome to network analysts so that they are able to i) compare clusters and assess inter-cluster similarity, ii) understand what features (and values thereof) are responsible for the formation of a given cluster, and iii) examine the hierarchical relationship amongst the groups formed.

In some examples, decision trees may be used to aid in clustering interpretation. Decision trees are conceptually simple, yet powerful, for supervised learning tasks (i.e., when labels are available) and their simplicity makes them easily understandable by human analysts. Specifically, the inventors are interested in classification trees.

In a classification tree setting, one is given N observations that consist of p inputs, that is xᵢ=(x₁, Xᵢ₂, . . . , xᵢₚ), and a target variable yᵢ. The objective is to recursively partition the input space and assign the N observations into a classification outcome taking values {1, 2, . . . , K} such that the classification error is minimized. For the application, the N observations correspond to the N Darknet events the inventors had clustered and the K labels correspond to the labels assigned by the clustering step. The p input features are closely associated with the P features used in the representation learning step. Specifically, the inventors still employ all the numerical features but the inventors also introduce the new binary variables i tags shown below in Table V. These “groupings”, based on domain knowledge, succinctly summarize some notable Darknet activities the inventors are aware of (e.g., Mirai scanning, backscatter activities, etc.) and, the inventors believe can help the analyst easily interpret the decision tree outcome.

TABLE V

| Feature | Description |
|---|---|
| darknet: remote | Ports: 22, 23 |
| darknet: mssql | Ports: 1433 |
| darknet: samba | Ports: 445 |
| darknet: rdp | Ports matching regex ‘\d+3389\d+’ |
| darknet: quote | Port: 17 |
| darknet: p2p Average | Ports matching regex ‘17\d\d\d’ |
| Packet Size | |
| darknet: amplification | Ports: 123, 53, 161, 137, 1900, 19, |
| | 27960, 270152 |
| censys: web | Tags: http, https |
| censys: remote | Tags: ssh, telnet, remote |
| censys: mssql | Tags: mssql |
| censys: samba | Tags: smb |
| censys: embedded | Tags: embedded, DSL, model, iot |
| censys: mgmt | Tags: cwmp, snmp |
| censys: storage | Tags: ftp, nas |
| censys: amplification | Tags: dns, ntp, memcache |
| scanning | TCP and ICMP scanning |
| backscatter | Protocols/flags associated with |
| | backscatter |
| UDP | Whether its UDP |
| Unknown/other | Other protocols/flags |

Traditionally, classification trees are constructed using heuristics to split the input space. These greedy heuristics though lead to trees that are “brittle, i.e., trees that can drastically change even with the slightest modification in the input space and there-fore do not generalize well. One can overcome this by using a decision tree based clustering interpretation approach. For example, tree ensembles or “random forests” are options, but may not be suitable for all interpretation tasks at hand since one then needs to deal with multiple trees to interpret a clustering outcome. Hence, in some embodiments, optimal classification trees are used, which are feasible to construct due to recent algorithmic advances in mixed-integer optimization and hardware improvements that speed-up computations.

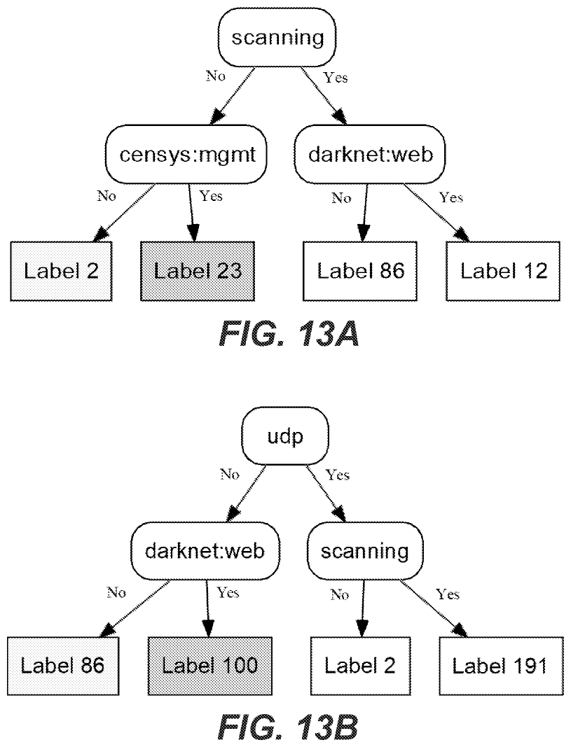

FIG. 13A shows an example optimal decision tree generated for 467, 293 Darknet events for Sep. 14, 2020. The structure of the tree, albeit minimal, is revealing. First, the leaves correspond to the largest 4 clusters (with sizes 14953, 11013, 10643 and 9422, respectively) found for September 14th, which means that the clusters with the most impact are captured. Another important observation is that the type of decision rules used to split the input space (namely, scanning, censys:mgtm and orion:remote) are indicative of the main Darknet activities during that day. Comparing with a non-optimal, heuristic-based decision tree (FIG. 13B), some important differences should be recognized: 1) two new clusters have emerged (with labels 100 and 191) that do not rank within the top-4 clusters (they rank 8th and 10th, respectively, with 6977 and 6404 members), and 2) there is some “redundancy” in the decision rules used for splitting when both the tags UDP and “scanning” are present. This is because UDP and scanning (i.e., TCP SYN requests and ICMP Echo Requests) are usually complementary to each other.

One of the important challenges in clustering is identifying characteristics of a cluster that distinguish it from other clusters. While the center of a cluster is one useful way to represent a cluster, it cannot clearly reveal the features and values that define the cluster. This is even more challenging for characterizing clusters of high-dimensional data, such as the scanner profiles in the network telescope. One can address this challenge by defining “internal structures” based on the decision trees learned. For example, the Conjuctive Normal Form representation of cluster internal structure can be derived from decision-tree based cluster interpretation results.

Given a set of clusters {C₁, C₂, . . . , Cₖ} that form a partition of a dataset D, a disjunctive normal forms (DNF) Sᵢ is said to be an internal structure of cluster C, if any data items in D satisfying Sᵢ are more likely to be in Cᵢ than in any other clusters. Hence, an internal structure of a cluster captures characteristics of the cluster that distinguishes it from all other clusters. More specifically, the conjunctive conditions of a path in the decision tree to a leaf node that predicts cluster Cᵢ forms the conjunctive (AND) component of the internal structure of Cᵢ. Conjunctive path description from multiple paths in the decision tree that predict the same cluster (say Cᵢ) are combined into a disjunctive normal form that characterizes the cluster Cᵢ. Hence, the DNF forms revealed by decision tree learning on a set of clusters expose the internal structures of these clusters.

### Detecting Clustering Changes

Given the proposed clustering framework, one can readily obtain scanner clusters on a daily basis (or at any other granularity of interest) and compare the clustering outcomes to glean insights on their similarities. This is desirable to security analysts aiming to automatically track changes in the behavior of the network telescope, in order to detect new emerging threats or vulnerabilities in a timely manner.

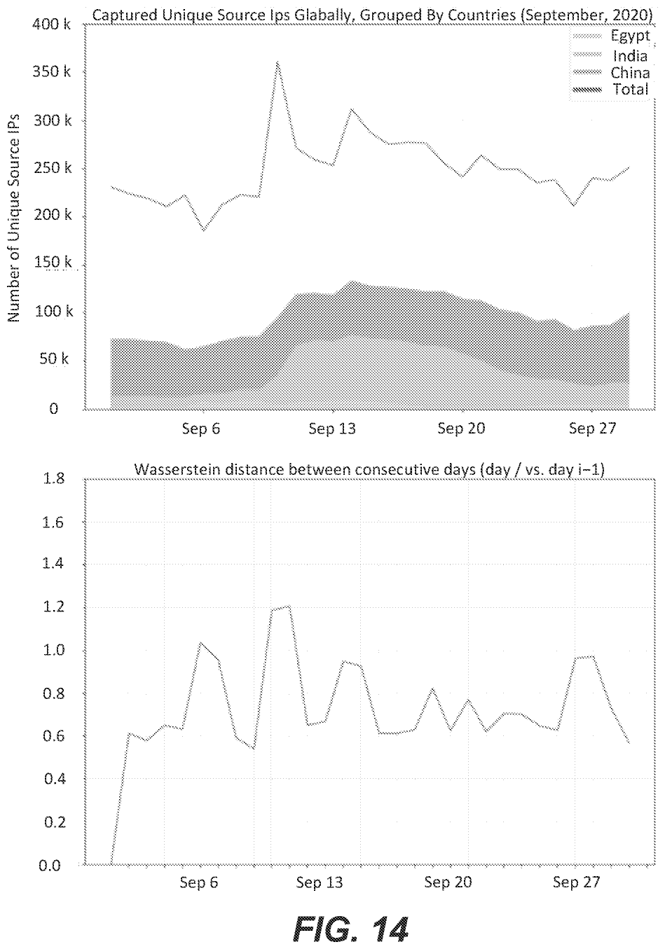

For example, FIG. 14 tracks the evolution of the network telescope for the whole month of September 2020. This compares the clustering outcome of consecutive days using a distance metric applied on the clustering profile of each pair of days. Some embodiments may use the Earth Mover's Distance which is a measure that captures the dissimilarity between two multi-dimensional distributions (also known as Wasserstein metric). Intuitively, by considering the two distributions as two piles of dirt spread in space, the Earth Mover's Distance captures the minimum cost required to transform one pile to the other. The cost here is defined as the distance (Euclidean or other appropriate distance) travelled to transfer a unit amount of dirt times the amount of dirt transferred. This problem can be formulated as a linear optimization problem and several solvers are readily available.

In some settings, each clustering outcome defines a distribution or “signature” that can be utilized for comparisons. Specifically, denote the set of clusters obtained after the clustering step as {C₁, C₂, . . . , Cₖ} and the centers of all clusters as {m₁, m₂, . . . , mₖ} where

$${m}_{i} = \frac{{\sum }_{j ∈ {C}_{i}} {x}_{j}}{\vert {C}_{i} \vert}$$

i={1, . . . , K}, xⱼ∈ [symbol] , j={1, . . . , N}. Then, the signature S={(m₁, w₁), (m₂, w₂), . . . , (m_{K}, w_{K})} can be employed, where w₁ represents the “weight” of cluster i which is equal to the fraction of items in that cluster over the total population of scanners. The results presented below were compiled by applying this signature on the clustering outcome of each day.

### Interpreting Changes of Scanning Behavior

Once a change of scanning behaviors is detected globally (e.g., using the Earth's Moving Distance), characterizing specific details of this change can translate this “signal” into an actionable intelligence by network security analysts by determining, for example: were there unusual ports scanning involved in this change? Where there a combination of unusual ports scanning with certain combination port scanning? Were there significant reduction of scanning of certain ports or port combinations?

Answering these questions can involve detecting and characterizing port scanning at a level more fine-grained than detecting changes at the global level described in the previous section. Therefore, it is desirable to follow a global change detection with a systematic approach to automate the detection and characterization of details of the port scanning changes. While answers to these questions can be generated using a range of approaches, one example approach is based on aligning clusters generated from two time points (e.g., two days). For purposes of illustration, the earlier time point as Day 1, the latter time point as Day 2. However, the two time points can be adjusted (e.g., two adjacent day) or further apart (e.g., separated by 7 days, 30 days, etc.) on the time scale.

The example benefits of this cluster alignment approach are that the approach is flexible because it is not designed to answer any specific questions. Instead, it tries to uncover clusters of day 2 that are not similar to any clusters of day 1. The internal structures of these “unusual” clusters can reveal fine grained characteristics of scanning behaviors of day 2 that are different from day 1. An example of a pseudocode algorithm for the cluster alignment approach is provided below:

```
Align (D1, D2)
for cluster C_D2_j in D2
    nearest_similarity(C_D2_j) = 0
    for cluster C_D1_i in D1
      if similarity(C_D2_j, C_D1_i) > nearest_similarity(C_D2_j)
        nearest_similarity(C_D2_j) = similarity(C_D2_j, C_D1_i)
        nearest_cluster_D1(C_D2_j) = C_D1_i
      NC_D1[C_D2_j] = <C_D2_j, nearest_cluster_D1(C_D2_j),
  nearest_similarity(C_D2_j)>
return NC_D1
Novel-clusters(D1, D2, threshold)
    NC_D1 = Align(D1, D2)
    NC_D1_filtered = filter NC_D1 for nearest_similarity value < threshold
```

The algorithm Align returns a key-value representation that stores the nearest cluster of day 1 (D1) for each cluster in day 2 (D2). The nearest cluster is computed based on two design choices: (1) an internal cluster representation (such as cluster center, a Disjunctive Normal Form described earlier, or other alternative representations) and (2) a similarity measure between the two internal cluster representations. For example, if cluster center is chosen to be the internal cluster representation, a candidate similarity measure is a fuzzy Jaccard measure, which is described below.

Based on the result of aligning clusters of Day 2 with those of Day 1, novel-clusters returns clusters whose similarity is below a threshold. One way to choose the threshold is using a statistical distribution of similarity of nearest clusters from 2-day cluster alignment results of a random samples from a Darknet dataset.

### Similarity Metric: Wasserstein Distance

The example methodology (i.e., clustering, detection of longitudinal structural changes using Earth Mover's Distance (EMD)) is demonstrated, when applied to a Darknet dataset in 2016, has been used to study the Mirai botnet. Let the vector a⁽ⁱ⁾ denote the cluster center for cluster i and the vector b^{(j)} denote the cluster center for cluster j. Vector a⁽ⁱ⁾ represents a probability mass with n locations with deposits of mass equal to 1/n. Similarly, b^{(j)} represents another probability mass with n locations, again with deposits of mass equal to 1/n. Given the two centers, a distance or dissimilarity metric can be used to determine how “close” cluster i is from cluster j. The p-Wasserstein distance with p=1 for the task at hand, defined as follows.

$${W}_{1} ( F , G ) = {\int }_{- ∞}^{∞} \vert F ( x ) - G ( x ) \vert dx , \qquad ( 1 )$$

where F(x) and G(x) are the empirical distributions for the locations a⁽ⁱ⁾ and b^{(j)}, respectively, defined as

$$F ( x ) = \frac{1}{n} {\sum }_{k = 1}^{n} [ {a}_{k}^{( i )} \leq x ] and G ( x ) = \frac{1}{n} {\sum }_{k = 1}^{n} [ {b}_{k}^{( j )} \leq x ] .$$

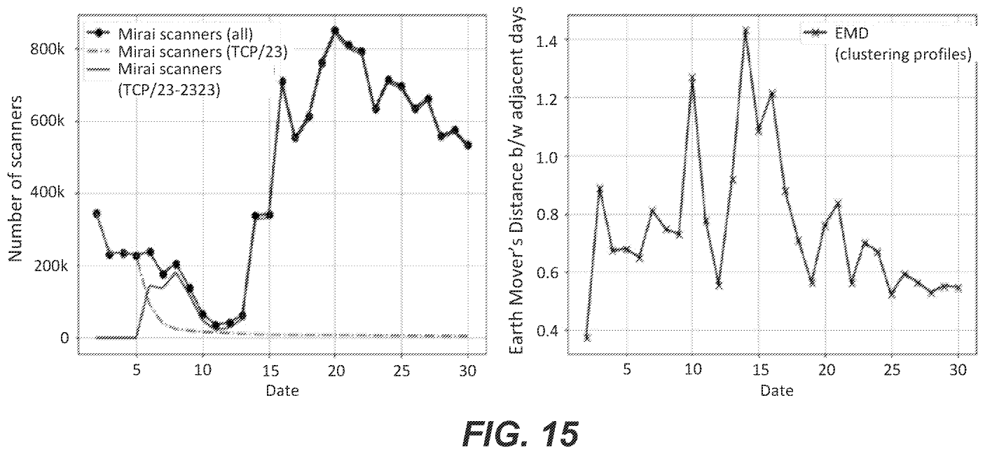

FIG. 15 illustrates this approach using the Mirai case study. FIG. 15 illustrates Mirai onset in late 2016 (left panel) and differences between clustering outcomes using a Wasserstein metric (right panel). The highest distance occurs on September 14^{th}. The graphs show the outset of the Mirai botnet. In some aspects, the Mirai botnet initially started scanning only for port TCP/23 but gradually port TCP/2323 was added into the set of ports scanned. The graphs showcase two important change-point events: one happening between the days of September 9 and 10, and the other occurring between the days of September 13 and 14. Both events are captured by the Wasserstein-based dissimilarity metric and illustrate at the right panel of graphs.

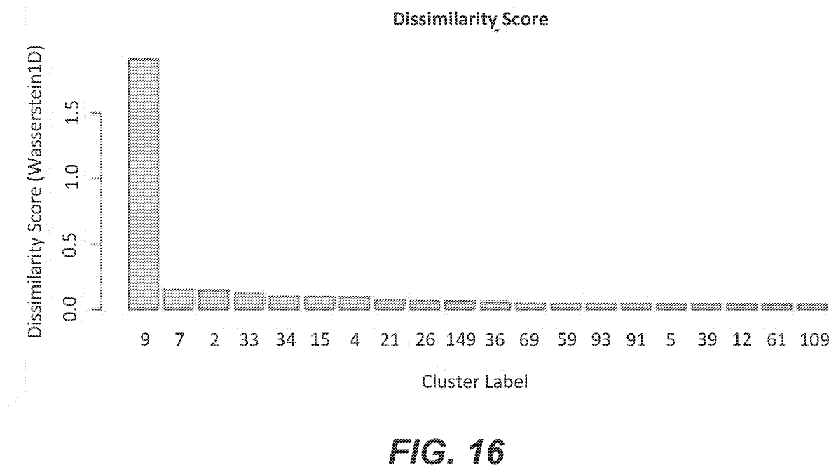

In addition to finding when a drastic shift has happened in the network telescope (such the two mentioned above), a user or operator may also want to identify the clusters that are causing the change. In such instances, a system can be programmed to follow the algorithm outlined earlier to identify these “novel clusters”. FIG. 16 shows the largest dissimilarity scores identified when all clusters of September 14th were compared with all clusters of September 13th using the Wasserstein metric introduced earlier. FIG. 16 shows the top-dissimilar clusters. Cluster 9 is therefore identified as the main “culprit” for the Darknet structure change detected; indeed, upon closer examination, cluster 9 consists of Mirai-related scanners searching for ports TCP/23 and TCP/2323 that were not present on September 13th.

### Similarity Metric: Jaccard Measure

The following illustrates an application of the algorithm above using clustering results of two days, separated by 9 days, in the first quarter of 2021. While the algorithm described above can be applied to clustering results generated from any feature designs for the Darknet data, the below illustrates aligning clustering results based on One Hot Encoding of top k ports scanned. In some examples, the alignment of clustering results of two time points can be based on a common feature representation. Otherwise, the alignment results can be incorrect, due to relevant features not present in one of the clusters being compared. While top k ports are one of the approaches for addressing high dimensionality of Darknet scanning data, in general, this choice of feature design can consider additional ports that may be included for cross-day clusters alignment for characterizing changes of scanning behaviors. Once a day's initial clustering result indicates changes based on Earth's Moving Distance discussed in the previous section, an earlier day may be chosen (e.g., the previous day, the day a week ago, etc.) for comparison, and the top k ports of the earlier day may be different. Under such a circumstance, the union of the top k ports from the two days can be chosen as the features for clustering and cross-day scanning change characterization.

Because top ports (union of top k ports from two days being compared) being scanned are one-hot encoded, the center of a cluster describes the percentage of scanners in the cluster that scan each of the top ports. Similarity between two cluster centers can be measured based on a fuzzy concept similarity inspired by the Jaccard measure:

$$sim ( {C}_{1} , {C}_{2} ) = \frac{{\sum }_{i} min [ μ {f}_{i} ( {C}_{1} ) , μ {f}_{i} ( {C}_{2} ) ]}{{\sum }_{i} max [ μ {f}_{i} ( {C}_{1} ) , μ {f}_{i} ( {C}_{2} ) ]}$$

where μfᵢ(C₁) denotes the value of the iₜₕ feature for cluster center C₁.

By applying the algorithm described above to clustering scanner profiles of two different days in the first quarter of 2021, several clusters of Day 2 are found to be very dissimilar to any clusters formed in Day 1. For the convenience of discussion below, these clusters will be referred to as “novel clusters”. Table VI. The six novel clusters in shown in the Table all have similarity below 0.04. Among these, the largest novel cluster (cluster 11) consists of more than 22K scanners. The next largest novel cluster (cluster 10) consists of close to 3K scanners. Interestingly, these two novel dusters also have the lowest similarity to their closest cluster in Day 1.

TABLE VI
Novel Clusters Identified

| | | | | Size of |
|---|---|---|---|---|
| Day 2 | | Closest | Day 2 | Closest |
| Cluster | | Day 1 | Cluster | Day 1 |
| Index | Similarity | Cluster | Size | Cluster |
| 11 | 0.0172 | 51 | 227289 | 32 |
| 138 | 0.0191 | 51 | 7059 | 32 |
| 47 | 0.0196 | 51 | 10192 | 32 |
| 124 | 0.0225 | 51 | 7231 | 32 |
| 72 | 0.0355 | 51 | 28488 | 32 |
| 142 | 0.0898 | 54 | 4936 | 1778 |

Table VII shows the cluster centers of these novel clusters. Columns are port number scanned by scanners in these novel clusters. An entry in the table represents the percentage of scanners in the cluster that scan the port listed in the column. For example, the table entry of value 1 for port 62904 on the first row indicates 100% of the scanners in cluster 11 scan port 62904. Each row in the table shows the center of the cluster whose ID is in the first column. The remaining columns correspond to ports being scanned by any of these novel clusters. Recall that the values of these port features are one-hot encoded (i.e., binary); therefore, the value of the cluster center for a specific port indicates the percentage of scanners in the cluster that scans the port. For example, cluster 10's center has the value 0.964 for port 62904, which means that 96.4% of the scanners in this cluster scan ports 62904. The table reveals that each of these novel clusters are very concentrated in the ports they scanned (each scanners scan either one or two ports). Interestingly, they also overlapped in the novel ports they scan. For example, cluster 10 and 11 overlap (more than 96%) on scanning port 62904. In fact, cluster 10 only differs from cluster II in scanning one additional port rarely scanned (port 52475). Three of the remaining four novel clusters also have significant overlapping ports as their targets. Cluster 60 scans only two ports, one (port 13599) is scanned by 1-port-scanners that form cluster 27, the other (port 54046) is scanned by one-port-scanners that form cluster 39. Cluster 58 scans only one novel port: 85550.

TABLE VII
Internal Structure of Novel Clusters

| Day 2 Cluster | | | | | | |
|---|---|---|---|---|---|---|
| Index | 8550 | 43293 | 62904 | 54046 | 52475 | 5353 |
| 11 | 0 | 0 | 1 | 0 | 0 | 0 |
| 138 | 0 | 0 | 0 | 1 | 0 | 0 |
| 47 | 1 | 0 | 0 | 0 | 0 | 0 |
| 124 | 0 | 1 | 0 | 0 | 0 | 0 |
| 72 | 0 | 0 | 1 | 0 | 1 | 0 |
| 142 | 0 | 0 | 0 | 0 | 0 | 1 |

Accordingly, for some embodiments temporal change monitoring can be thought of as occurring in two phases. First, a temporal subset of past data (e.g., the day prior, 12-24 hours ago, 2-4 hours ago, etc.) can be compared to more current data (e.g., today's data, the most recent 12 hours, the most recent 2 hours, etc.). And, these comparisons can take place on a global/Internet-wide basis (through access to large scale Darknet data) or from a given enterprise system. In some embodiments, it may be desirable to simultaneously gather and compare multiple periodicities of data, to obtain the long term benefit of more data over longer periods (giving more ability to create finer clusters and detect subtle changes) as well as the near term benefit of detecting attacks and scanning campaigns as/before they occur. Data for each periodicity to be monitored is then clustered and characterized per the techniques identified above.

Second, pairs of data groupings (e.g., sequential 2 hour pairs, current/previous day, last overnight vs. current overnight, etc.) are analyzed according to several possible approaches. One example approach uses all features of the clusters together (including categorical features like ports scanning/scanned, as well as numerical features like bytes sent, and statistical measures like Jaccard measures of differences in packets set), and matches clusters from the current data grouping to the most similar clusters from the previous grouping to find the similarities. In some embodiments, similarity scores can be used between the clusters, in other embodiments common features of the clusters can be identified, and in yet other embodiments both approaches can bet taken. If the most similar past cluster has low similarity to a current cluster (i.e., the current cluster appears meaningfully different than previous activities), then those clusters can be identified as potentially relevant. As described in the examples below, when a new cluster is detected, various actions can be taken depending on the characteristics of the cluster. In some embodiments, a user may apply various thresholds or criteria for degrees of difference before a new cluster is flagged as important for further action. And, in other embodiments, the thresholds or criteria may be dynamic depending on the characteristics of the cluster. For example, a cluster that is rapidly growing may warrant flagging for further action, even if the degree of difference of the cluster from past clusters is comparatively lower. As another example, a cluster that appears to be exhibiting scanning behavior indicative of a new major attack may be flagged giving the importance of the characteristic of that cluster. In further examples, a new cluster may emerge and can be indicative of scanning activities attempting to compile lists of NTP or DNS servers that could be later used to employ amplification-based DDoS attacks.

### Evaluation

Evaluation Using Synthetic Data: Due to the lack of “ground truth”, evaluating unsupervised machine learning methods like clustering is challenging. In order to tackle this problem, synthetic data can be generated to evaluate the example framework, i.e., artificially generated data that mimic real data. The advantage of such data is that different “what-if” scenarios can be introduced to evaluate different aspects of the example framework.

Synthetic Data Generation: A generative model can be used based on Bayesian networks to generate synthetic data that capture the causal relationships between the numerical features in the present disclosure. To learn the Bayesian network, the hill-climbing algorithm implemented in R's bnlearn package can be used. In some examples, features can be used from a typical day of the network telescope to learn the structure of the network, which is represented as a directed acyclic graph (DAG). The nodes in the DAG can represent the features and the edges between pairs of nodes can represent the causal relationship between these nodes.

Let X₁, . . . , Xₙ denote the nodes of the Bayes network. Their joint distribution can be expressed as [symbol] (x₁, . . . , xₙ)=Πᵢ₌₁ⁿ [symbol] (xᵢ|parents (Xᵢ)), where parents (Xᵢ) denote the parents of node Xᵢ that appear in the DAG. IT can be shown that for every variable in the network Xᵢ, the equation below can be expressed:

$$( {X}_{i} \vert {X}_{1} , … , {X}_{n} ) = ( {X}_{i} \vert parents ( {X}_{i} ) ) .$$

This relationship can be satisfied if the nodes in the Bayes net are numbered in a topological order. Given this specification of the joint distribution, a Monte Carlo randomized sampling algorithm can be processed to obtain data points for the example synthetic dataset. In the Monte Carlo approach, all variables X₁, . . . , Xₙ as Gaussian random variables with a joint distribution N(μ, Σ), and hence the conditional distribution relationships can be employed for multivariate Gaussian random variables. The parameters μ and Σ are estimated from the same real network telescope dataset to learn the Bayes net.

Embedding evaluation: linear vs nonlinear autoencoders: In some examples, several techniques can be devised that reduce the dimensionality of data without losing much information contained m the data. Principal Component Analysis (PCA) is a widely used dimensionality reduction technique that reduces the data dimensionality by performing “change of basis” using the principal components that are determined based on the variability in the data. Despite its simplicity and effectiveness in linear data. PCA doesn't perform well on non-linear data. Modern deep-learning based autoencoders are designed to learn low dimensional representation of input data. If properly trained, these autoencoders can encode data to very low dimensions with extremely low information loss.

The most widely used approach to compare embedding techniques is to calculate the information loss. The embeddings are used to decode the original data and the difference between the decoded data and the original data is the information loss caused by embedding. The example experiments with synthetic data shows that MLP autoencoders can encode Darknet data to a very low dimensional latent space with extremely negligible information loss. However, in order to achieve same-level of low information loss with PCA, the size of the latent space needs to be increased and often times, it is almost impossible to achieve the same performance as autoencoders.

Other than the information loss, the power of synthetic data can be harnessed to apply application-specific comparison between PCA and autoencoder. The synthetic data is designed with a fixed number of clusters. KMeans clustering is applied on the PCA embeddings and autoencoder embeddings. The clustering outcomes are compared using Jaccard score (calculated as intersection of original clusters and predicted clusters). In some examples, when the first 10 principal components are used, the example clustering algorithm might not capture the actual number of clusters. The clustering algorithm determines the number of clusters in the data to be 60 when the actual number of clusters is 50. Even after increasing the number of principal components used to 50, PCA embeddings fail this test. The Jaccard Score keeps on increasing without actually capturing the real value of K. On the other hand, in case of autoencoder, both latent space size of 10 and 50 capture the real number of clusters. This shows that autoencoder trumps over PCA even when low latent size is used.

Comparison with Related Work: The example methodology, can be juxtaposed with state-of-the-art related work, namely the DarkVec approach. DarkVec's authors allow researchers to access their code and data, and the comparisons are based on the provided data Specifically, the last day of the 30-day dataset is used (see Table VIII).

TABLE VIII
Basic statistics for example Darknet datasets

| | Darknet | | | | | | |
|---|---|---|---|---|---|---|---|
| Dates | Size | Sources | Packets | Ports | Port | Traffic [%] | Sources |
| [2016 Sep. 2, | /10 | 35M | 49B | 65536 | 23 | 60.34 | 20.5M |
| 2016 Sep. 30] | | | | | 80 | 13.55 | 963K |
| | | | | | 2323 | 4 | 13.5M |
| Sep. 14, 2016 | /10 | 1.8M | 1.5B | 65536 | 23 | 53.3 | 808K |
| | | | | | 2323 | 11.39 | 527K |
| | | | | | 80 | 6.83 | 96K |
| Sep. 24, 2016 | /10 | 3.3M | 1.4B | 65536 | 23 | 69.45 | 1.8M |
| | | | | | 2323 | 7 | 1.3M |
| | | | | | 80 | 3.73 | 84K |
| Feb. 20, 2022 | /13 | 845K | 3.1B | 65536 | 6379 | 6.67 | 2.5K |
| | | | | | 23 | 5.1 | 122K |
| | | | | | 22 | 2.17 | 10.4K |

In some example, the same semi-supervised approach that Dark-Vec used for its comparisons with other methods can be employed. Since no “ground truth” exists for clustering labels when working with real-world Dark-net data, labels can be assigned based on domain knowledge; e.g., known scans projects and/or known signatures such as the Mirai one; an “unknown” label is assigned to the rest of the senders. The complete list of the nine “ground truth” labels utilized can be found (see Table IX).

TABLE IX
Traffic types

| | Fraction of Scanners |
|---|---|
| Traffic Type | (%) |
| TCP-SYN | 91.17 |
| TCP-SYN, UDP | 4.04 |
| UDP | 2.48 |
| ICMP Echo Request | 0.61 |
| TCP-SYN, UDP, ICMP Dest. Unreachable | 0.47 |

The semi-supervised approach can evaluate the quality of the learned embeddings. Intuitively, the embeddings of all scanners belonging in the same “ground truth” class (e.g., Mirai) should be “near” each other according to some appropriate measure. The semi-supervised approach can involve the usage of a k-Nearest-Neighbor (k-NN) classification algorithm that assigns each scanner to the class of its k-nearest neighbors based on a majority voting rule. Using the leave-one-out approach, each scanner is assigned a label, and the overall classification accuracy can be evaluated using standard metrics such as precision and recall.

In some examples, the autoencoder-based embeddings can be constructed for the example approach disclosed above on the last day of the 30-day dataset. The DarkVec embeddings, which are acquired via word embeddings techniques such as Word2Vec, were readily available (see dataset embeddings_d1_f30.csv.gz). Using this dataset, Dark-Vec was shown to perform better than alternatives such as IP2VEC (see Table X) and thus the comparisons can be obtained against DarkVec. Table X tabulates the results. The semi-supervised approach using the embeddings shows an overall accuracy of 0.98 whereas DarkVec's embeddings lead to a classification accuracy score of 0.90.

TABLE X
Comparison with Dark Vec

| | Dark Vec Embeddings | | | Autoencoder Embeddings | | | |
|---|---|---|---|---|---|---|---|
| | | | F1- | | | F1- | |
| | Precision | Recall | score | Precision | Recall | score | Support |
| Mirai-like | 1 | 0.91 | 0.95 | 1 | 0.99 | 0.99 | 7351 |
| Binaryedge | 0.98 | 0.93 | 0.95 | 1 | 0.92 | 0.96 | 101 |
| Censys | 0.99 | 0.9 | 0.94 | 1 | 0.98 | 0.99 | 336 |
| Engin-umich | 1 | 1 | 1 | 1 | 1 | 1 | 10 |
| Internet-census | 0.99 | 0.99 | 0.99 | 1 | 0.89 | 0.94 | 103 |
| Ipip | 0.45 | 0.67 | 0.54 | 1 | 0.92 | 0.96 | 49 |
| Sharashka | 0.83 | 1 | 0.91 | 1 | 1 | 1 | 50 |
| Shodan | 1 | 0.7 | 0.82 | 1 | 0.74 | 0.85 | 23 |
| Stretchoid | 1 | 0.14 | 0.25 | 1 | 1 | 1 | 104 |

| | | |
|---|---|---|
| Accuracy | 0.9 | 0.98 |

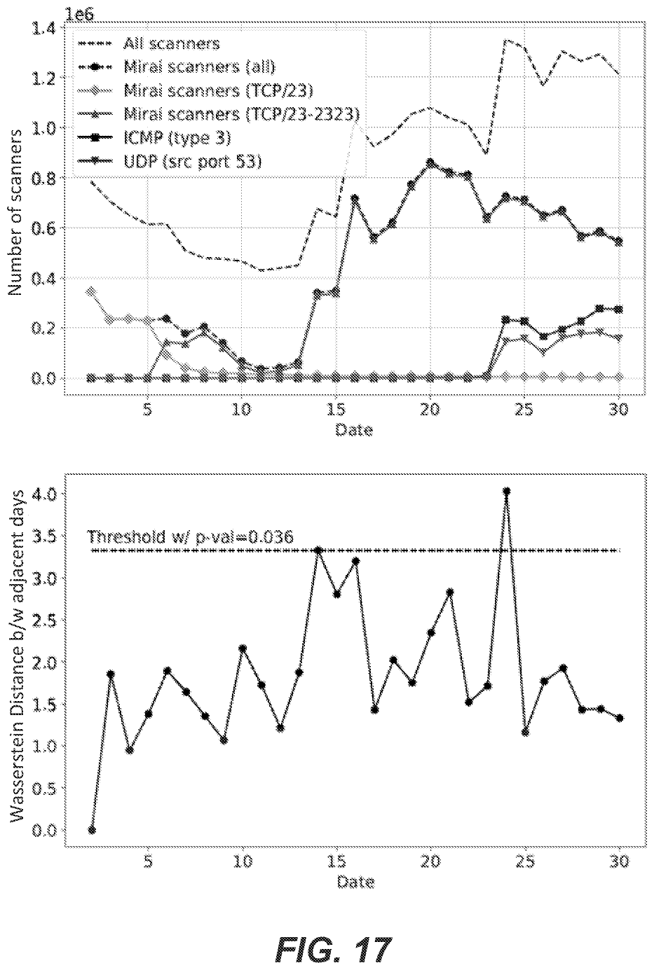

Validation using Real World Network Telescope Data: In some examples, the example approach can be validated using real-world data (see Table X). First, the complete methodology can be evaluated on a month-long dataset that includes the outset of the Mirai botnet (see FIG. 17). Then, the example clustering approach can be applied on a recent dataset (i.e., Feb. 20, 2022) to showcase some important recent Darknet activities that the example system diagnoses. FIG. 17 shows scanning traffic (top panel) at Merit's Darknet (a /10 Darknet, back then) for September 2016 and detection (bottom panel) of temporal changes in the Darknet using the Wasserstein distance. In some examples, the expansion of the Mirai botnet, namely the addition of TCP/2323 in the set of ports scanned. FIG. 17 considers scanners emitting at least 50 packets per day.

September 2016: The Mirai onset. Starting on September 2nd, the example autoencoder can be employed to obtain the desirable embeddings and then cluster the (filtered) network telescope scanners to obtain K=200 groups for each day of the month. Then, applied the techniques of change-point detection described above to calculate the Wasserstein distance and associated transport plan between consecutive days.

FIG. 17 (bottom panel) shows the time-series of 2-Wasserstein distances for September 2016. As can be seen, at a significance level of 5%, two change-points are identified; one for September 14th (with p-value=0.036) and another for September 24th (with p-value=0). On September 16th, p-value=0.071 is obtained. The p-values are calculated using the set of all Wasserstein distances estimated for the whole month.

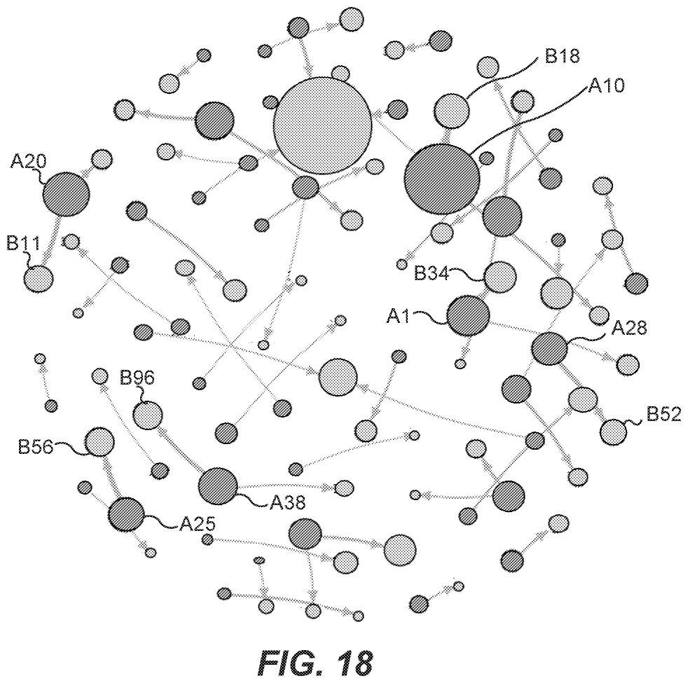

Let G=(V, E) be a weighted directed graph with V:={Aᵤ}∪{Bᵤ}, u 1, . . . , K, denoting the graph's nodes, where node Aᵤ corresponds to cluster-u in day-0 and Bᵤ to cluster-u in day-1, respectively. (u, v)∈E if and only if γ*ᵤᵥ≥0, i.e., there is some amount of mass transferred from cluster-u of day-0 to cluster-v of day-1. The edge weights wᵤᵥ, (u, v)∈E are defined as wᵤᵥ:=γ*ᵤᵥ. The graph in FIG. 18 shows the graph extracted based on the optimal transport plan γ* for the clustering outcomes of September 13 and September 14. In the graph, only edges with γ*ᵤᵥ≥0.01 are shown. It can shed light into the clustering changes that occurred between the two days. For instance, FIG. 18 and Table IV show that most mass is moved from cluster A10 (largest cluster of September 13) to cluster B₁₈. Examining Table TV indicating that these 2 Mirai-like clusters are quite similar with regards to the features that characterize their scanners. The fact that B₁₈ is a much smaller Mirai cluster than A₁₀ suggests that there was a decreasing trend in the amount of Mirai-related scanners that solely targeted port TCP/23. Indeed, the second largest mass transfer was between A₁ and B₃₄, and in this case showing that cluster B₃₄ captures the introduction of port TCP/2323 in the set of ports scanned by Mirai (see Table XI). Similar insights can be obtained by inspecting cluster pairs (A₂₅, B₅₆), (A₂₀, B₁₁), (A₂₈, B₅₂), (A₃₈, B₉₆), and others not shown here for space economy. By inspecting FIG. 17 (top) one can validate that the change between the 2 days can actually be attributed to the changing tactics of the Mirai botnet. In some examples, though, that without the automated methodology proposed here, capturing this change would use monitoring an enormous amount of time series (e.g., the scanning traffic to all ports) which is practically infeasible.

TABLE XI
Interpretation of clustering changes between Sep. 13 and Sep. 14, 2016.

| | | | | | | Avg. | | # | # | | | | | | |
|---|---|---|---|---|---|---|---|---|---|---|---|---|---|---|---|
| Day | Label | Mass | Jaccard | Size | Packets | IA | Bytes | DstPorts | DstAddr | TTL | Freq. | Traffic | Freq. | Ports | Freq. |
| 13 | 10 | | | 21247 | 1513 | 24586 | 0 | 1.1 | 854 | 50 | 19628 | TCP-SYN | 21213 | 23 | 19674 |
| 14 | 18 | 0.022 | 0.18 | 15174 | 1313 | 29594 | 0 | 1.5 | 904 | 50 | 13300 | TCP-SYN | 15137 | 23 | 8345 |
| 13 | 1 | | | 12145 | 1821 | 29673 | 0 | 1.1 | 1058 | 53 | 11906 | TCP-SYN | 12139 | 23 | 11391 |
| 14 | 34 | 0.020 | 0.17 | 13410 | 1145 | 29472 | 0 | 1.6 | 815 | 53 | 12834 | TCP-SYN | 13408 | 23-2323 | 6911 |
| 13 | 25 | | | 10236 | 1669 | 27095 | 0 | 1.2 | 960 | 49 | 9762 | TCP-SYN | 10235 | 23 | 9438 |
| 14 | 56 | 0.019 | 0.18 | 12862 | 1412 | 27172 | 0 | 1.3 | 975 | 49 | 11186 | TCP-SYN | 12861 | 23 | 9113 |
| 13 | 20 | | | 12906 | 2259 | 29468 | 0 | 1.7 | 1107 | 47 | 12193 | TCP-SYN | 12891 | 23 | 11982 |
| 14 | 11 | 0.017 | 0.18 | 11744 | 1343 | 33147 | 0 | 2 | 824 | 47 | 11233 | TCP-SYN | 11730 | 23 | 7291 |
| 13 | 28 | | | 9244 | 2058 | 28640 | 0 | 1.8 | 1148 | 45 | 8944 | TCP-SYN | 9235 | 23 | 8759 |
| 14 | 52 | 0.017 | 0.12 | 11312 | 1179 | 30244 | 0 | 2.1 | 850 | 45 | 10842 | TCP-SYN | 11303 | 23-2323 | 6055 |
| 13 | 38 | | | 9851 | 2369 | 27181 | 0 | 1.8 | 1277 | 46 | 9705 | TCP-SYN | 9730 | 23 | 9465 |
| 14 | 96 | 0.015 | 0.15 | 11001 | 1391 | 35617 | 0 | 2.2 | 920 | 46 | 8559 | TCP-SYN | 10800 | 23 | 7936 |

As shown in FIG. 17, the most significant clustering change was detected for September 23-24 Surely, in FIG. 17 (top) a dramatic increase can be seen in the amount of Darknet traffic associated with UDP flooding and ICMP messages with Type 3 (Destination Unreachable). Upon closer inspection, UDP can be been with src port 53 and ICMP messages with the message destination port 53 unreachable. The payload of these messages point to the conclusion that these are indicators of heavy nefarious DNS scanning, captured in the network telescope as “DNS backscatter.” Within the UDP and ICMP packets, DNS A-record queries under the domain xy808.com can be seen with randomly looking subdomains. This is a common technique that scanners embrace in order to identify open DNS resolvers while at the same time concealing their identity. The list of compiled open DNS resolvers can then be used in volumetric, reflection and amplification DDoS attacks. To put things in perspective, some of the largest Mirai-based DDoS attacks occurred on September 25th (against Krebs on Security) and on Oct. 21, 2016 (against Dyn). Thus, it can be known that the Mirai operators were the ones behind these heavy DNS scanning activities.

Having confirmed that the change-point for September 23-24 is a “true positive” malicious event, the optimal transport plan y is consulted to see how one can interpret the alert raised. Table XII tabulates the top-6 pairs of clusters with the largest amount of “mass” transferred. In Table XII, rows in gray scale indicates the formation of a new large cluster (cluster 24), associated with a DDoS attack. The pair (A47, B24) indicates there was high transfer of mass to cluster B24 which is associated with ICMP (type 3) activities. In contrast with the other row-pairs in the table, the fact that mass gets transferred from A47 to B24 indicates the formation of a novel cluster, the Jaccard similarity between the set of source IPs of the 2 clusters is zero, and their scanning profile varies significantly.

TABLE XII
Interpretation of clustering changes between Sep. 23 and Sep. 24, 2016.

| | | | | | | Avg. | | | | | | | | | |
|---|---|---|---|---|---|---|---|---|---|---|---|---|---|---|---|
| Day | Label | Mass | Jaccard | Size | Packets | IA | Bytes | #DstPorts | #DstAddr | TTL | Freq. | Traffic | Freq. | Ports | Freq. |
| 23 | 13 | | | 22294 | 2890 | 29704 | 0 | 2 | 1282 | 45 | 22096 | TCP-SYN | 22208 | 23-2323 | 22099 |
| 24 | 63 | 0.025 | 0.14 | 37923 | 1196 | 53657 | 10 | 2 | 792 | 45 | 36858 | TCP-SYN | 37520 | 23-2323 | 37322 |
| 23 | 9 | | | 20659 | 1404 | 52025 | 89 | 2 | 1011 | 47 | 20038 | TCP-SYN | 20539 | 23-2323 | 20430 |
| 24 | 60 | 0.023 | 0.16 | 31479 | 914 | 61293 | 19 | 2 | 781 | 47 | 25513 | TCP-SYN | 31195 | 23-2323 | 29094 |
| 23 | 28 | | | 24152 | 851 | 52845 | 0 | 2 | 686 | 47 | 23893 | TCP-SYN | 24141 | 23-2323 | 19273 |
| 24 | 25 | 0.022 | 0.12 | 24422 | 648 | 58031 | 0 | 2 | 537 | 47 | 25423 | TCP-SYN | 29387 | 23-2323 | 21269 |
| 23 | 81 | | | 31276 | 1681 | 43937 | 32 | 2 | 1036 | 46 | 31086 | TCP-SYN | 31094 | 23-2323 | 31028 |
| 24 | 1 | 0.021 | 0.18 | 32827 | 1228 | 53974 | 21 | 2 | 881 | 46 | 32637 | TCP-SYN | 32536 | 23-2323 | 32437 |
| 23 | 11 | | | 23792 | 759 | 42032 | 0 | 2 | 663 | 53 | 23241 | TCP-SYN | 23787 | 23-2323 | 21545 |
| 24 | 29 | 0.021 | 0.11 | 28586 | 509 | 51834 | 0 | 2 | 444 | 53 | 28152 | TCP-SYN | 28583 | 23-2323 | 26336 |
| 23 | 47 | | | 19833 | 1477 | 56862 | 5 | 2 | 1090 | 48 | 17331 | TCP-SYN | 19702 | 23-2323 | 19592 |
| 24 | 24 | 0.017 | 0.00 | 23594 | 145 | 434328 | 5971 | 2 | 145 | 48 | 22803 | ICMP | 23146 | 0 | 23204 |
| | | | | | | | | | | | | (type 3) | | | |

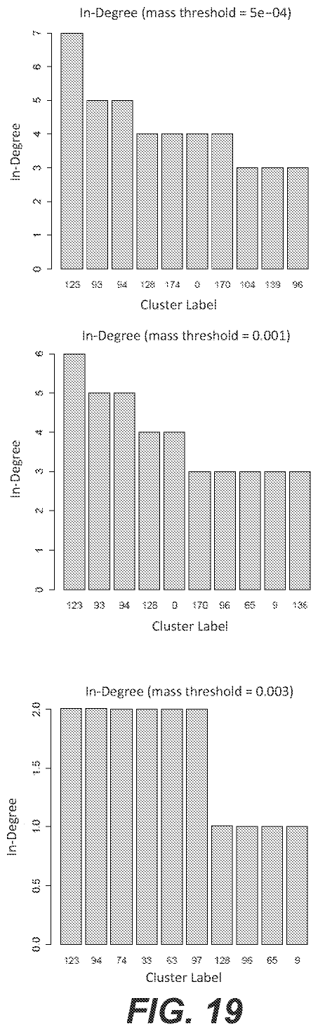

FIG. 19 shows the in-degrees for the graph G induced by the optimal transport plan of September 23-24. In the three panels shown, the edges for which γ*ᵤᵥ<τ were pruned, where threshold τ∈{5×10⁻⁴, 0.001, 0.003}. In some examples, cluster B123 stands out as the one with the highest in-degree in all three cases. The fact that the “optimal transport plan” includes transferring high amounts of mass from several different clusters (of the previous day) to cluster B123 indicates that the latter is a novel cluster. Indeed, the members of B123 are associated with UDP messages with src port 53, and as illustrated in FIG. 17 this activity started on September 24th.

Cluster inspection: 2022 Feb. 20 dataset. Next, recent activities identified in the network telescope can be discussed when the example clustering approach is applied, the dataset for Feb. 20, 2022 can be used (see Table VIII). In total, Merit's Darknet observed 845,000 scanners for that day; after the filtering step a total of 223,909 senders remain. They are grouped into the categories shown in Table XIII.

TABLE XIII
Cluster Inspection (2022 Feb. 20)

| | # of | |
|---|---|---|
| Description | Clusters | # of Senders |
| Mirai-related | 70 | 108,912 |
| Unknown | 67 | 76,525 |
| SMB | 20 | 23,700 |
| Heavy Scanners | 19 | 2,377 |
| ICMP scanning | 5 | 2,619 |
| Ack Scanners | 4 | 795 |
| SSH scanning | 4 | 2,635 |
| censys.io | 3 | 147 |
| TCP/3389 (RDP) | 2 | 1,482 |
| UDP/5353 | 2 | 3,212 |
| Backscatter (DDoS) | 2 | 815 |
| TCP/6379 (Redis) | 1 | 437 |
| Normshield | 1 | 253 |
| TOTAL | 200 | 223,909 |

70 Mirai-related clusters including 108912 scanners were found. The scanners were classified as “Mirai-related” due to the destination ports they target and the fact that their traffic type is TCP-SYN. Some examples do not observe the characteristic Mirai fingerprint in all of them (i.e., setting the scanned destination address equal to the TCP initial sequence number). This implies the existence of several Mirai variants. In fact, some examples see several combination of ports being scanned, such as “23”, “23-2323”, “23-80-8080”, “5555” and even largest sets like “23-80-2323-5555-8080-8081-8181-8443-37215-49152-52869-60001.” The vast majority of these clusters appear with Linux/Unix-like TTL fields, indicating they are likely compromised IoT/embedded devices.

The next large category of network telescope scanners is one with unusual activities that the inventors cannot attribute to some known malware or specific actor; the inventors hence deem these activities as “Unknown”. Their basic characteristic is that they involve mostly UDP traffic and they target “high-numbered” ports such as port 62675. Upon inspection of the TTL feature, these group of clusters includes both Windows and Linux/Unix OSes. For many of these clusters, the country of origin for these scanners is China.

20 clusters associated with TCP/445 scanning (i.e., the SMB protocol) were identified. Several ransomware-focused malware (such as WannaCry) are known to be aiming to exploit SMB-related vulnerabilities. Members of these clusters are usually Windows machines.

Further, the inventors detected a plethora of “heavy scanners”, some performing scanning for benign purposes (e.g., Censys.io, Shodan) and others engaged in nefarious-looking activities. Four clusters include almost exclusively of acknowledged scanners, i.e., IPs from research and other institutions that are believed to not be hostile. Four other clusters (three from Censys and one from Normshield) are also benign clusters that scan from IPs not yet included in the “acknowledged scanners” list. Some clusters in the “Heavy Scanners” category exhibit interesting behavior: e.g., 1) some scan with extremely high speeds (five clusters have mean packet inter-arrival times less than 10 msecs), 2) ten clusters probe all or (close to all) IPs that the network telescope monitors, 3) two clusters scan almost all 2⁶⁴ ports, 4) one cluster sends an enormous amount of UDP payload to 16 different ports, and 5) two clusters are engaged in heavy SIP scanning activities.

Also, a cluster associated with TCP/6379 (Redis) scanning including 437 scanners were identified. Table XI shows that TCP/6379 is the most scanned port in terms of packets on 2022 Feb. 20. The example clustering procedure grouped this activity within a single cluster which indicates orchestrated and homogeneous actions (indeed, members of that cluster scan extremely frequently, probe almost all Darknet IPs, are Linux/Unix-based, and originate mostly from China). The inventors further uncovered two clusters performing TCP/3389 (RDP) scanning, two clusters targeting UDP/5353 (i.e., DNS) and two clusters that capture “backscatter” activities, i.e., DDoS attacks based on spoofing.

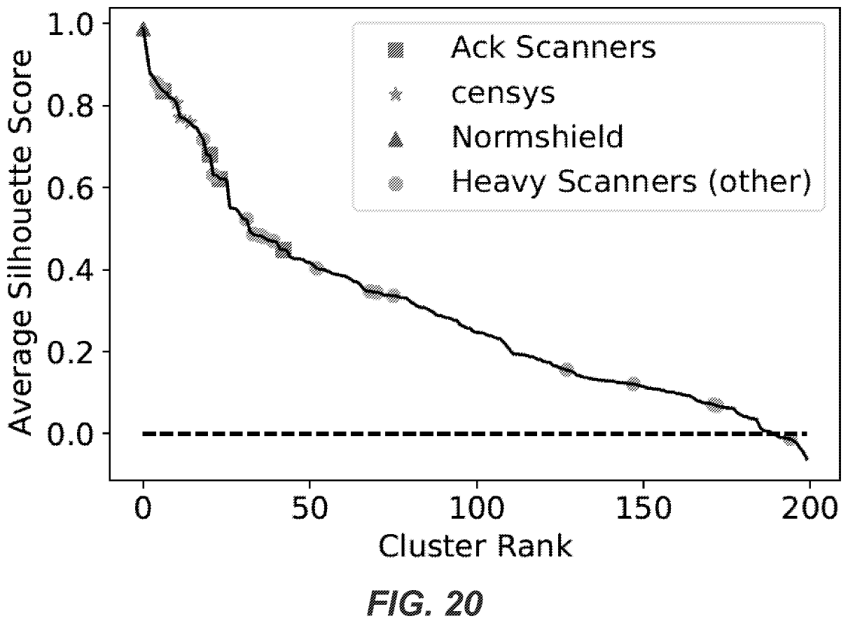

FIG. 20 demonstrates the average silhouette score for each cluster of the 2022 Feb. 20 dataset. The silhouette score takes values between −1 (worst score) and 1 (perfect score), and indicates if a cluster is “compact” and “well separated” from other clusters. The inventors annotate the plot of silhouette scores with some clusters associated with orchestrated scanning activities, the 4 clusters of “Acknowledged Scanners”, the 3 “Censys” clusters, the cluster for Normshield, and 18 clusters from the “Heavy Scanners” category (the left-out cluster includes only a single scanner corresponding to NETSCOUT's research scanner; the silhouette score for singleton clusters is undefined). The inventors chose clusters like these since their members (i.e., the senders) are usually engaged in similar behavior (e.g., sending about the same amount of packets, targeting the same number of ports, etc.) and are thus good examples to demonstrate the clustering performance. As expected, the silhouette scores for the vast majority of these clusters are quite good (≥0.33). However, for few clusters the silhouette score is close to 0. While the inventors still get meaningful insights from these clusters (e.g., cluster 162, with score −0.01, indicates extreme scanning activity against almost all Darknet IPs with its members scanning an average of 5,753 unique ports), their silhouette score is low because of intra-cluster variability in some of their features (e.g., the TTL values). If necessary, the analyst can resort to hierarchical clustering and re-partition the clusters with low scores.

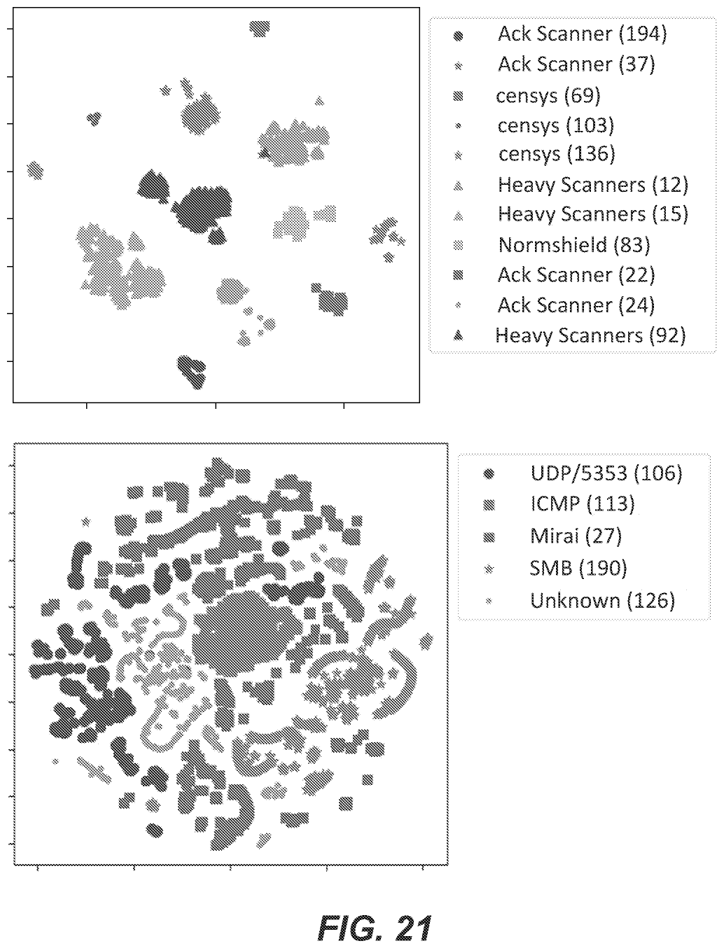

FIG. 21 shows t-SNE visualizations for some select clusters. Specifically, the inventors illustrate some clusters of acknowledged/heavy scanners that exhibit high average silhouette scores. The inventors also depict the largest cluster for each of these categories: Mirai, “Unknown”, SMB, ICMP scanning and UDP/5353. The t-SNE projections are learned from the 50-dimensional embeddings acquired from the example autoencoder step. Thus, the signal is quite compressed: nevertheless, the inventors are still able to observe that similar scanners are represented with similar embeddings.

### Aspects Useful for Understanding Certain Embodiments

Network scanning is a component of cyber attacks, which aims for identifying vulnerable services that can be exploited. Even though some network scanning traffic can be captured using existing tools, analyzing them for automated characterization that enables actionable cyber defense intelligence remains challenging for several reasons:

(1) One machine that scans the internet (i.e., which the inventors refer as a scanner) can scan tens of thousands of ports in a day. This type of scanning behaviors (also referred to as “vertical scanning”) results in an extremely high dimensionality of the scanning data, which present challenges for data analytics and clustering. This challenge is addressed by certain embodiments described herein through a combination of deep representation learning and novel encoding methods described in the present disclosure.

(2) Scanning network traffic is mixed with normal network traffic in the operational network. Distinguishing scanning network traffic from normal ones is challenging because it may attempt to behave like normal network traffic (e.g., reduce the speed of scanning) so that they are difficult to be detected. This challenge can be addressed by certain embodiments described herein by using scanning data collected by network telescope or firewall log described in the present disclosure.

(3) Interpreting scanning clusters generated is challenging due to the large number of features associated with individual scanners and the complex and often unclear relationships between these features. For example, the number of packets and the number of bytes sent by a scanner is correlated: yet they can be useful to distinguish scanners that sent large packets from those that sent small packets. This disclosure addresses this challenge by setting forth certain embodiments using multiple approaches: (1) extract internal structure of clusters using decision tree learning, (2) generate probabilistic graph models from the data as well as from each cluster.

(4) Scanning behaviors can change drastically over time (e.g., number of scanners that scan a port increase rapidly). They can also change in an unusual way (e.g., significant number of scanners scan a port that has not been heavily scanned previously). Detecting these changes in a reliable and scalable way is the third challenge. The present disclosure addresses this challenge by developing multiple scalable data analytics methods/embodiments for detecting and characterizing changes, both at the macro scale (e.g., using Earth Mover's Distance) and at the micro scale (e.g., by aligning clusters of two different days based on the similarity of their internal cluster structures).

(5) Translating analytics results into actionable cyber defense intelligence is challenging due to the complexity and the constantly-changing tactics and strategies of cyber attackers. The present disclosure addresses this challenge by describing embodiments which deploy systematic and robust linking of scanner characteristics with vulnerability data such as Common Vulnerabilities and Exposures (CVE) system.

### Example Implementations

Intrusion detection. In some implementations, the techniques described above (including, e.g., temporal change detection) can be implemented so as to provide an early warning system to enterprises of possible intrusions. While prevention of malware attacks is important, detection of malware scanning and intrusion into an enterprise is a critical aspect of cybersecurity. Therefore, a monitoring system following the principles described herein can be implemented, which can monitor scanning behavior of malware and what malware is doing. If a monitoring system detects that a new cluster is being revealed, the system can: identify primary sources (e.g., IP addresses) of the new scanning activity and make determinations of possible origin of the malware. Where sources of the new scanning activity are originating from a common enterprise, the system can immediately alert the operators of the enterprise that there are newly-compromised devices in their network. And, the system can alert the owners of the behavior of the compromised devices which can provide opportunities to mitigate penetration of the malware and improve security for future attacks.

In other instances, the monitoring software may detect new clusters forming and alert cybersecurity management organizations or cyber-insurance providers whenever one of their customers appears to have experienced an intrusion or owns an IP address being spoofed.

Early cyberattack signals. In addition to detection of intrusions that may have already occurred, other embodiments may also provide early signals that an attack may be imminent. For example, systems operating per the principles identified above may monitor Darknet activity and create clusters. Using change detection principles, new types of activities can be identified early (via, e.g., detection of newly-forming clusters, or activity that has the potential to form its own cluster). Thus, if attacker launches a significant new attack, and the system sees increased activity or new types of activities (e.g., changes that might signal a new attack) the system can flag these as critical changes.

Importantly, these increased activities may not themselves be the actual attack, but rather a prelude or preparation for a future attack. In some DDOS attacks, for example, attackers first scan the Internet for vulnerable servers that can be compromised and recruited for a future DDOS attack which will occur a few days later. Using the principles described above, increased scanning activity that exhibits characteristics of server compromise can be detected and/or the actual compromise of servers that could be utilized for a DDOS attack can be detected. Then, in the hours/days prior to the actual amplified attack, customers of the system may be able to employ a patch or update to quickly mitigate danger of a DDOS attack, or the owners of the compromised servers could take preventative action to remove malware from their systems and/or prevent scanning behavior.

In instances where attacks may be imminent, the system could recommend to its customers that they temporarily block certain channels/ports likely to be involved in the attack, if doing so would incur minimal interference to the business/network, to allow more time to remove the malware and/or install updates/patches.

Descriptive Alerts. In some embodiments, alerts provided to subscribers or other users can provide higher level characterizations of clusters of Darknet behavior that may help them take mitigating action. For example, clustering of certain Darknet activity may help a user understand that an attacker might be spoofing IP addresses, as opposed to an actual device at that IP address being compromised. Similarly, temporal change detection could be applied to various subdomains or within enterprises known to belong to certain categories (e.g., defense, retail, financial sectors, etc.).

In other embodiments, a scoring or ranking of the importance of an alert could be provided. For example, a larger cluster may mean that a given vulnerability is being exploited on a larger scale, or scores could be based on known IP addresses or the amount of traffic per IP (how aggressive). Rate of infection and rate of change of a cluster could also assist a user in determining how much a new attack campaign is growing. Relatedly, the port that is being scanned can give some information on function of the malware behind the scanning.

The above systems and methods have been described in terms of one or more preferred embodiments, but it is to be understood that other combinations of features and steps may also be utilized to achieve the advantages described herein. In some embodiments, any suitable computer readable media can be used for storing instructions for performing the functions and/or processes described herein. For example, in some aspects of the disclosure, computer readable media can be transitory or non-transitory. For example, non-transitory computer readable media can include media such as magnetic media (such as hard disks, etc.), optical media (such as compact discs, digital video discs, Blu-ray discs, etc.), semiconductor or solid state media (such as RAM, Flash memory, electrically programmable read only memory (EPROM), electrically erasable programmable read only memory (EEPROM), etc.), cloud-based remote storage, and any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term ‘system’ can encompass hardware, software, firmware, or any suitable combination thereof.

It should be understood that steps of processes described above can be executed or performed in any suitable order or sequence not limited to the order and sequence shown and described in the figures. Also, some of the above steps of the can be executed or performed substantially simultaneously where appropriate or in parallel to reduce latency and processing times.

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for computer scanning activity detection, comprising:
receiving Darknet data associated with scanning activities of a plurality of scanners;
determining a plurality of sets of features corresponding to the plurality of scanners based on the Darknet data;
generating a plurality of embeddings based on a deep autoencoder, the plurality of embeddings corresponding to the plurality of sets of features to reduce dimensionality of the plurality of sets of features;
generating a plurality of clusters based on the plurality of embeddings using a clustering technique; and
detecting a temporal change in the plurality of clusters.

2. The method of claim 1, wherein a set of features of the plurality of sets corresponds to a scanner of the plurality of scanners,
wherein the scanning activities of the plurality of scanners are within a predetermined period of time, and
wherein the set of features comprises at least one of: a traffic volume, a scanning scheme, a targeted application, or a scanner type of the scanner.

3. The method of claim 2, wherein the traffic volume of the scanner within the predetermined period of time comprises at least one of a total number of packets transmitted, a total amount of bytes transmitted, or an average inter-arrival time between packets transmitted.

4. The method of claim 2, wherein the scanning scheme within the predetermined period of time comprises at least one of: a number of distinct destination ports, a number of distinct destination addresses, a prefix destiny, or a destination scheme.

5. The method of claim 2, wherein the targeted application within the predetermined period of time comprises at least one of a set of ports scanned, or a set of protocol request types scanned.

6. The method of claim 2, wherein the scanner type of the scanner within the predetermined period of time comprises at least one of: a set of time-to-live (TTL) values of the scanner, or a device operating system (OS) type.

7. The method of claim 1, wherein the plurality of sets of features comprises heterogeneous data containing at least one categorical dataset for a feature and at least one numerical dataset for the feature.

8. The method of claim 1, wherein the plurality of sets of features is projected onto a representation space, via a nonlinear autoencoder function, the representation space having a lower dimensionality than the Darknet data.

9. The method of claim 1, wherein the deep autoencoder comprises a fully-connected multilayer perceptron neural network.

10. The method of claim 9, wherein the fully-connected multilayer perceptron neural network uses two layers.

11. The method of claim 1, further comprising:
training the deep autoencoder by minimizing a reconstruction loss based on the plurality of sets of features and the plurality of embeddings.

12. The method of claim 11, further comprising:
generating a plurality of decoded input datasets by decoding the plurality of embeddings to map the plurality of decoded input datasets to the plurality of sets of features.

13. The method of claim 12, wherein the reconstruction loss is minimized by minimizing distances between the plurality of sets of features and the plurality of decoded input datasets, the plurality of sets of features corresponding to the plurality of decoded input datasets.

14. The method of claim 1, wherein the clustering technique comprises a k-means clustering technique clustering the plurality of embeddings into the plurality of clusters, and
wherein a number of the plurality of clusters is smaller than a number of the plurality of embeddings.

15. The method of claim 14, wherein the plurality of clusters comprises a first clustering assignment matrix and a second clustering assignment matrix, wherein the first clustering assignment matrix and the second clustering assignment matrix being for adjacent time periods.

16. The method of claim 15, further comprising:
generating a first probability density function capturing the first clustering assignment matrix; and
generating a second probability density function capturing the second clustering assignment matrix.

17. The method of claim 16, wherein the detecting the temporal change comprises transmitting an alert when a distance between the first probability density function and the second probability density function.

18. The method of claim 17, wherein the distance is a 2-Wasserstein distance on the first probability density function and the second probability density function.

19. A system for malicious activity detection, comprising:
at least one processor;
a communication device connected to the processor and configured to receive data reflective of network activity;
a memory having stored thereon a set of instructions which, when executed by the processor, cause the processor to:
receive Darknet data associated with scanning activities of a plurality of scanners;
determine a plurality of sets of features corresponding to the plurality of scanners based on the Darknet data;
generate a plurality of embeddings based on a deep autoencoder, the plurality of embeddings corresponding to the plurality of sets of features to reduce dimensionality of the plurality of sets of features;
generate a plurality of clusters based on the plurality of embeddings using a clustering technique; and
detect a temporal change in the plurality of clusters.

20. A system for detecting malicious computer activity, comprising:
at least one processor;
at least one network connection in communication with the at least one processor; and
at least one memory having stored thereon a set of instructions which, when executed by the processor, cause the processor to:
receive a first set of Darknet data via the at least one network connection, corresponding to a first temporal period;
cluster the first set of Darknet data to create first cluster data;
receive a second set of Darknet data via the at least one network connection, corresponding to a second temporal period;
cluster the second set of Darknet data to create second cluster data;
generate similarity information comparing the first cluster data and the second cluster data;
determine at least one of: (i) an existence of a cluster within the second cluster data that is not within a similarity threshold of any clusters of the first cluster data; or (ii) a change in characteristics of a given cluster from the first cluster data to the second cluster data; and
alert a user to the determination of (i) or (ii).
